(19) United States
(12) Patent Application Publication
(10) Pub. No.: US 2004/0112836 A1
(43) Pub. Date: Jun. 17, 2004

(54) Oil and gas well fracturing (frac) water treatment process

(76) Inventors: David Harold Manz, Calgary (CA); Tariq Mahmood, Calgary (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/316,068

(22) Filed: Dec. 11, 2002

(51) Int. Cl. C02F 1/52

(52) U.S. Cl. 210/721; 210/724

(57) ABSTRACT

This invention relates to a novel process for treating and removing undesirable impurities from oil and gas well fracturing fluid. A method for treating fracturing water comprising: (a) passing contaminated fracturing water containing solids and liquid through a mechanical separator to remove solids from the liquid; (b) treating the fracturing water liquid with an alkaline agent to increase the pH of the liquid to a level of above 9; (c) adding a coagulant to the fracturing water to form an agglomerate and separating the agglomerate from the fracturing water; (d) reducing the pH of the fracturing water of step (c) to a level of less than about 5.5; and (e) adding an oxidizing agent to the fracturing water of step (d) to oxidize oxidizable impurities in the fracturing water.

### FIELD OF THE INVENTION

This invention relates to a novel process for treating and removing undesirable impurities from oil and gas well fracturing fluid and rendering the water suitable for re-use.

### BACKGROUND OF THE INVENTION

Hydraulic fracturing (fracing) is a process applied to drilled oil and gas well holes to improve the ability of fluids (such as oil and gas) to flow from the petroleum and gas bearing formation (target reservoir rock) to the hole. Hydraulic fracturing involves injecting high pressure fracturing fluid into the target reservoir rock, usually with additives, thereby causing the rock to fracture circumferentially away from the hole. Since the weight of the overlying formations will force the fractures to close once the pressure of the fluid is removed, sand or other grains, known as “proppant”, are introduced into the fractures to keep them open, and help the formation fluid to flow to the hole. Once the fracturing process is completed, nearly all of the injected hydraulic fluid is recovered during the time the oil and gas flows from the formation into the hole and up to the well surface. The fracturing technique is often necessary for economical well production.

The fluids used in hydraulic fracturing vary from pure water to gummy gels. Pure “water fracs” do not contain environmentally hazardous substances. Other frac treatments contain various substances to improve the flow characteristics and effectiveness of the frac fluid in fracturing the rock formation. Some frac additives are toxic and may not be suitable for treatments in active aquifers, but most additives are not toxic. All fracture treatments are engineered to limit the frac fluids to the hydrocarbon formation zone being treated.

Common well fracturing additives are listed below. The dosage rates vary with the location and condition of the well. These chemicals become an integral part of the frac fluid (blowback water) that is ultimately recovered.

| | |
|---|---|
| Foamers and antifoams | Surfactants |
| Gellants and gel breakers | Viscosifiers |
| Emulsifiers and de-emulsifiers | Cross linkers |
| Biocides | |

Fracture fluid volumes can vary from a few hundred gallons to over 100,000 gallons per well. Most of the frac fluid is immediately recovered as blowback water. The nature and composition of this “frac water” is significantly different from normal oil and gas production brines that exist naturally and are obtained from the petroleum bearing formation when the well is completed. With the increasing emphasis by regulatory bodies on minimizing environmental impact, disposing of “frac water” has become a problem, especially if it contains environmentally offensive additives.

U.S. Pat. No. 4,536,293, Babineaux, granted Aug. 20, 1985, discloses a method of treating waste water. The method involves purifying waste water from oil well rigs in order that the water may be suitable for reuse on the rig or disposed of conventionally. The method incorporates a series of aerators and corresponding collection tanks to first aerate and then collect the waste water. In each collection tank, sediment is precipitated to the bottom of the tank permitting the clear water to overflow from the collection tank. A soluble aluminum salt is added to the waste water at an initial stage of aeration in order to coagulate the waste particles within the water and form solid precipitates which then settle to the tank bottom. The clearer water is then passed through subsequent aerators and sedimentation tanks until ultimately the water may be disposed of without polluting or contaminating the environment.

U.S. Pat. No. 5,093,008, Clifford, granted Mar. 3, 1992, discloses a process and apparatus for recovering reusable water from waste drilling fluid. The process and apparatus involves a concurrent reutilization in an active drilling operation of a storage area, an intermixer for introducing treatment chemicals into the waste drilling fluid and a centrifuge. Flocculation of solids in the waste water is chemically induced as it passes through the intermixing means. The waste drilling fluid is then transferred to the centrifuge where it is separated into solid waste and clear reusable water.

U.S. Pat. No. 6,132,619, Lin et al., granted Oct. 17, 2000, discloses a method of resolving solid/emulsion formed as a result of acidification of oil and gas wells. The method includes the steps of adding an iron-control chemical in an amount sufficient to prevent the formation of insoluble iron compounds and adding a water dispersible emulsion breaker in an amount sufficient to separate the sludge emulsion into clean oil and water. Further treatment of the waste water includes utilization of water clarifiers, settling vessels and passing the fluid through a macroreticular resin which results in clarified water. Inorganic metal salts such as alum, aluminum chloride and aluminum chlorohydrates and organic polymers such as acrylic acid based polymers are used in treating the sludge emulsion formed by the acidized wells.

### SUMMARY OF INVENTION

The invention is directed to a method for treating fracturing water comprising: (a) passing contaminated fracturing water containing solids and liquid through a mechanical separator to remove solids from the liquid; (b) treating the fracturing water liquid with an alkaline agent to increase the pH of the liquid to a level greater than 9.0; (c) adding a coagulant to the fracturing water liquid to form an agglomerate and separating the agglomerate from the fracturing water liquid; (d) reducing the pH of the fracturing water liquid of step (c) to a level of less than about 5.5; and (e) adding an oxidizing agent to the fracturing water liquid of step (d) to oxidize oxidizable impurities in the fracturing water liquid.

The oxidation and acidification steps (d) and (e) can be reversed. Hydrated lime and caustic soda can be added at step (b) to increase the pH of the fracturing water liquid to a level of above about 9.0. A flocculating agent can be added to the fracturing water along with the coagulant in step (c). An inorganic acid can be added to the fracturing water at step (d) to reduce the pH to less than 5.5.

The water that is produced from the second clarification step can be passed through a sand water filter or a sediment cartridge filter to remove remaining particles in the liquid.

In step (d), the liquid can be neutralized by reducing the pH to about 7.0. The neutralization and oxidation steps (d) and (e) can be reversed.

The fracturing water liquid that remains after coagulated and flocculated agglomerate particles are removed after step (e) can be subjected to a second clarification step which can include a second acidification step, followed by an oxidation step.

A coagulant can be added to the fracturing water liquid during the second clarification step. A flocculent can also added during the second clarification step. The fracturing water liquid from the second clarification step can be neutralized before being reused as water. The water that is produced from the second clarification step can be passed through a sand water filter or a sediment cartridge filter to remove carryover particles in the liquid.

The fracturing water liquid in step (a) can be oxidized after being mechanically separated and before proceeding to step (b), and in step (d) the pH of the liquid can be reduced to about 7.0 A flocculating agent can be added along with a coagulant in step (c).

### BRIEF DESCRIPTION OF DRAWINGS

In drawings which illustrate specific embodiments of the invention, but which should not be construed as restricting the spirit or scope of the invention in any way:

FIG. 1 illustrates a flow sheet setting out a series of operations according to the invention to treat spent frac water so that it is converted to acceptable and reusable water.

### DETAILED DESCRIPTION OF SPECIFIC EMBODIMENTS OF THE INVENTION

The inventors have developed a process to treat the blowback from water fracs to achieve a quality of clarified water suitable for reuse.

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The process according to the invention involves a number of complex reactions utilizing various chemicals at different stages followed by a finishing (polishing) treatment. The oil-water-mineral complex suspensions are removed during this process. The synthetic emulsifiers, de-emulsifiers, gellants and metallic cross linkers present in the frac water are suppressed at high respective acidic and alkaline conditions in the presence of de-emulsifiers, coagulants and surfactants. The flocculated particles are removed in a subsequent clarification process.

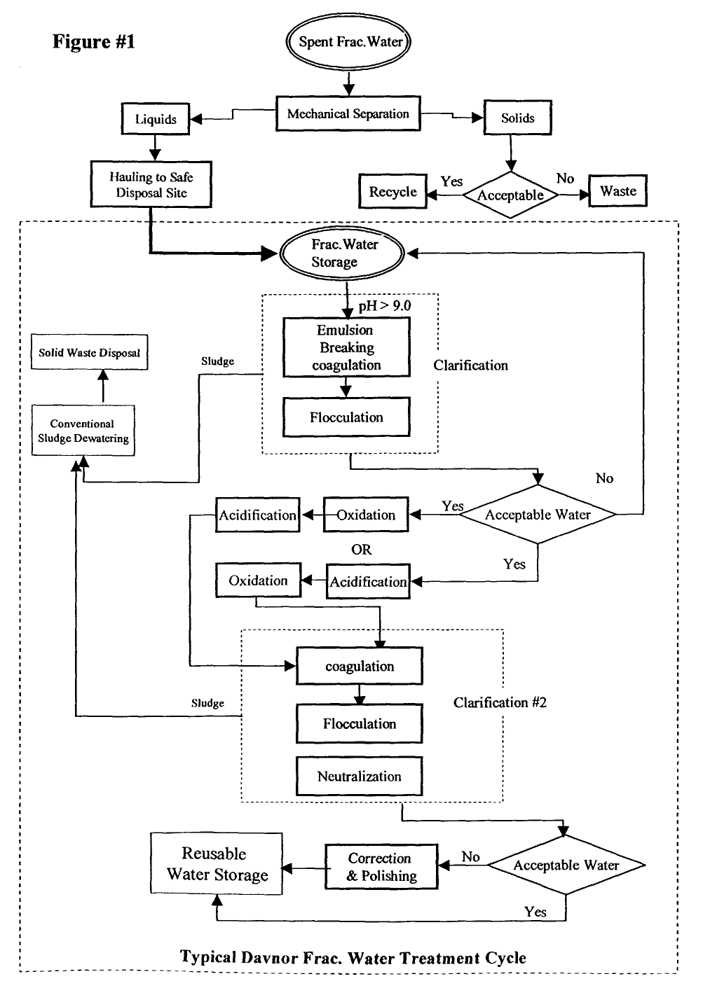

FIG. 1 illustrates a typical set of operations according to the invention that are carried out on spent frac water collected from blowback. Various methods that have been successfully utilized to treat the frac water are shown in Table 1.

Clarification #1

Hydrated lime and caustic soda are used to increase the water pH to a level above about 9.0. At this high water pH, the inter-molecular attractions between hydrocarbon and anionic poly-gels are interrupted and tiny hydrocarbon particles along with surface-active poly-gels are adsorbed on a calcium carbonate suspension. A highly cationic coagulant/de-emulsifier is introduced at this stage to agglomerate these suspended particles in combination with anionic poly-gels. Most of the metallic cross-linkers are also separated from the frac water during this process. The propagation of this phenomenon requires careful pH monitoring and timely correction to maintain the preferred pH (preferably above 9).

Acidification

The clarified water obtained after separating the flocculated material is acidified to reduce the pH to less than about 5.5 using a suitable inorganic acid. This step eliminates excess alkalinity and releases cross-linked metallic ions.

Oxidation

The organic and metallic reducing agents released at the low pH of the acidification step are removed by an oxidation process. Strong oxidizing agents with a suitable end point identification are utilized in this oxidation step. The sequence of the acidification and oxidation steps can be reversed in appropriate situations.

Clarification #2

In this second stage, coagulants and/or polymers are added to the fluid to agglomerate the metallic ions released by the oxidation step. The water is neutralized with a caustic/lime solution which promotes the formation of floe which can be separated easily by filtration or some other suitable process.

Polishing and Correction Treatment

Certain specialty chemicals and reducing agents are introduced in this step to correct the treated water components to desired product specifications. A slow sand water filter can be utilized to polish the corrected water and remove particles carried over from the clarifiers.

The chemical consumption and sludge volume that is produced in each case depends upon the specific well site and the fracturing chemicals that have been used. Chemical demand is established for each batch separately. Approximately 15-30% vol. of sludge is produced during this process. The actual sludge volume varies with the frac-fluid composition. The sludge treatment and disposal procedure depends upon the location of the treatment facility.

Continuous Operation

Water is collected from various well sites and transported to a central treatment and disposal facility. As composition of the frac fluid varies with fracturing treatment at the various well sites, stabilization of the frac-water blend is required for effective treatment. A minimum 48 hrs. holding capacity is necessary for smooth operation. Bench testing of the raw and treated water at intervals is essential for proper process monitoring and quality control. Bench and pilot scale testing is used to establish the design parameters for each treatment facility.

Referring to FIG. 1 in detail, FIG. 1 illustrates a flow sheet setting out a series of operations to treat spent frac water so that it is converted to acceptable and reusable water. As illustrated in the flow sheet in FIG. 1, the spent frac water is subjected initially to a mechanical separation whereby solids are removed from the frac water by any suitable solid separation technique such as filtration. The solids, if deemed acceptable for recycling, are recycled to the process. Alternatively, if the solids are not acceptable, they are disposed to waste.

The liquids obtained from the solids-liquid mechanical separation process are hauled to a safe disposal site such as a frac water storage pond or tank. The frac water from the storage pond or tank is then subjected to treatment to raise the pH above 9.0 to destabilize the emulsified particles. Coagulants and flocculants are introduced to promote floe formation and clarification. The sludge produced in his process is delivered to a conventional sludge de-watering process and subsequently to solid waste disposal.

The clarified water obtained after the initial flocculation procedure is then tested to see if the water is acceptable as measured by expectations for clarification. If the water is not acceptable, it is recycled to the frac water storage pond or tank for reprocessing. If the water is found to be acceptable after the initial flocculation clarification process, the pH of the water is reduced to less than about 5.5 and is then subjected to oxidation, followed by acidification, or in the alternative, acidification followed by oxidation. The water obtained from the acidification/oxidation or oxidation/acidification steps is then subjected to a second clarification step. At that point, the water is treated with suitable coagulants and flocculants and neutralized. The flocculated solids are then delivered as sludge to a conventional sludge de-watering step and ultimately to solid waste disposal. Water that remains after the flocculated solids are removed is then tested according to specifications to see if the water is acceptable for delivery to reusable water storage. If the resultant water is not acceptable, it is subjected to corrective and polishing steps before being delivered to the reusable water storage container.

Table 1 illustrates a number of alternative methods that can be used according to the invention to accommodate different frac water treatment conditions and requirements. In the case of Methods 1A and 1B, the first clarification step is identical except for the fact that the oxidation and acidification steps are reversed, according to required conditions. Clarification step #2 in each case is similar in that acid neutralization or neutralization is utilized before the polishing step.

Method 1C is similar to Method 1D except that in the first clarification step, the oxidation and acidification steps are reversed. The second clarification steps are identical.

Methods 2A, 2B, 2C and 2D are simplified methods, compared to Methods 1A, 1B, 1C and 1D, in that only a first clarification step is utilized. This process can be used in cases where the frac water is not particularly heavily contaminated. In Methods 2A and 2B, the respective first clarification steps are the same except that the oxidation and acidification steps are reversed. In Methods 2C and 2C, only a coagulation step, and no flocculation step, is followed. Again, in Methods 2C and 2D, the oxidation and acidification steps are reversed.

Methods 3A, 3B, 3C and 3D are similar to one another, and in a general sense, to the methods disclosed in Methods 2A, 2B, 2C and 2D. However, in Method 3A, a neutralization step rather than an acidification step is utilized in association with oxidation, neutralization and oxidation being reversed in each method. Methods 3C and 3D are similar to Methods 3A and 3B except there is no flocculation step. The second stage in all of Methods 3A, 3B, 3C and 3D involve a chemical correction step prior to the polishing step.

Lastly, Methods 4A and 4B both utilize only a first clarification step. In Method 4A, flocculation is utilized prior to neutralization and polishing, whereas in Method 4B, there is no flocculation step after coagulation, prior to neutralization and polishing.

TABLE 1
FRAC WATER TREATMENT METHODS

| | Method - 1A | Method - 1B | Method - 1C | Method - 1D |
|---|---|---|---|---|
| Stage #1 | | | | |
| Step #1 | Clarification #1 | Clarification #1 | Clarification #1 | Clarification #1 |
| | pH adjustment > 9.0 | pH adjustment > 9.0 | pH adjustment > 9.0 | pH adjustment > 9.0 |
| | Coagulation | Coagulation | Coagulation | Coagulation |
| | Flocculation | Flocculation | — | — |
| Step #2 | Oxidation | Acidification | Oxidation | Acidification |
| Step #3 | Acidification | Oxidation | Acidification | Oxidation |
| Stage #2 | | | | |
| Step #1 | Clarification #2 | Clarification #2 | Clarification #2 | Clarification #2 |
| | Coagulant | Coagulant | Coagulant | Coagulant |
| | Flocculation | Flocculation | Flocculation | Flocculation |
| Step #2 | Acid Neutralization | Neutralization | Neutralization | Neutralization |
| Step #3 | Polishing | Polishing | Polishing | Polishing |
| | Method - 2A | Method - 2B | Method - 2C | Method - 2D |
| Stage #1 | | | | |
| Step #1 | Clarification #1 | Clarification #1 | Clarification #1 | Clarification #1 |
| | pH adjustment > 9.0 | pH adjustment > 9.0 | pH adjustment > 9.0 | pH adjustment > 9.0 |
| | Coagulation | Coagulation | Coagulation | Coagulation |
| | Flocculation | Flocculation | — | — |
| Step #2 | Oxidation | Acidification | Oxidation | Acidification |
| Step #3 | Acidification | Oxidation | Acidification | Oxidation |
| Stage #2 | | | | |
| Step #1 | Polishing | Polishing | Polishing | Polishing |
| | Method - 3A | Method - 3B | Method - 3C | Method - 3D |
| Stage #1 | | | | |
| Step #1 | Clarification #1 | Clarification #1 | Clarification #1 | Clarification #1 |
| | pH adjustment > 9.0 | pH adjustment > 9.0 | pH adjustment > 9.0 | pH adjustment > 9.0 |
| | Coagulation | Coagulation | Coagulation | Coagulation |
| | Flocculation | Flocculation | — | — |
| Step #2 | Neutralization | Oxidation | Neutralization | Oxidation |
| Step #3 | Oxidation | Neutralization | Oxidation | Neutralization |
| Stage #2 | | | | |
| Step #1 | Chem. Correction | Chem. Correction | Chem. Correction | Chem. Correction |
| Step #2 | Polishing | Polishing | Polishing | Polishing |

| | Method - 4A | Method - 4B |
|---|---|---|
| Stage #1 | | |
| Step #1 | Oxidation | Oxidation |
| Step #2 | Clarification #1 | Clarification #1 |
| | pH adjustment > 9.0 | pH adjustment > 9.0 |
| | Coagulation | Coagulation |
| | Flocculation | — |
| Step #3 | Neutralization | Neutralization |
| Stage #2 | | |
| Stage #2 | Polishing | Polishing |

As can be seen, the process according to the invention is versatile and can be successfully and readily adapted to accommodate a wide range of contaminated frac water obtained from various oil and gas wells.

The following charts illustrate data obtained from four tests performed by Maxxam Analytics Inc. on four different four cubic meter samples of frac water obtained from an operating oil/gas company in southern Alberta, using the applicants' water treatment process.

The first three pages of data for each of the four tests report physical parameters for raw untreated frac water blow back. The next three pages report physical parameters for the respective frac water samples after a single clarification step according to the process of the invention. The last three pages report physical parameters for the respective frac water samples after two clarification steps according to the invention. Of note in each of the four tests is the dramatic reduction in turbidity from four digit to two digit numbers after a single clarification step, and a reduction from two digit to single digit numbers after a second clarification step.

After a single clarification step, most of the toxins and all of the suspended solids had been removed and the water could safely be disposed of in Class 1 and 2 wastewater disposal wells without any danger of damaging the disposal well. The single clarification step water could also be disposed of in municipal wastewater treatment systems, land spreading or reused in another oilfield process.

After a second clarification step, all samples were considered recyclable for use in a new fracing process as determined by Halliburton Oil Field Services Laboratory in Red Deer, Alberta. The concentration of toxic substances and suspended solids had been reduced to negligible levels and reuse of this water for a variety of oilfield and other purposes was possible.

| | | | |
|---|---|---|---|
| Sample | FW-B#1, RAW | Maxxam Sample | 355477 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS ON FIRST
RAW FRAC WATER SAMPLE

| | | | | | | |
|---|---|---|---|---|---|---|
| PARAMETER | | | | QA/QC | | |
| DESCRIPTION | RESULTS | Units | INST. | Batch | MDL | RDL |

Calculated
Parameters

| | | | | | | |
|---|---|---|---|---|---|---|
| Anion Sum | 65.0 | meq/L | CALC | 196406 | N/A | N/A |
| Cation Sum | 56.5 | meq/L | CALC | 196406 | N/A | N/A |
| Hardness | 330 | mg/L | CALC | 196402 | 0.5 | 1 |
| (CaCO3) | | | | | | |
| Ion Balance | 0.87 | N/A | CALC | 196404 | 0.01 | 0.02 |
| Misc. | | | | | | |
| Inorganics | | | | | | |
| Conductivity | 6760 | uS/cm | ECEL | 196519 | 0.02 | 0.04 |
| pH | 7.38 | N/A | TITR/ALK | 196522 | N/A | N/A |
| Anions | | | | | | |
| Alkalinity | <0.5 | mg/L | TITR/ALK | 196515 | 0.5 | 1 |
| (PP as CaCO3) | | | | | | |
| Alkalinity | 2090 | mg/L | TITR/ALK | 196515 | 0.5 | 1 |
| (Total as CaCO3) | | | | | | |
| Bicarbonate | 2550 | mg/L | TITR/ALK | 196515 | 0.5 | 1 |
| (HCO3) | | | | | | |
| Carbonate (CO3) | <0.5 | mg/L | TITR/ALK | 196515 | 0.5 | 1 |
| Dissolved | 766 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide (OH) | <0.5 | mg/L | TITR/ALK | 196515 | 0.5 | 1 |
| Dissolved | 74.6 | mg/L | IC/EC | 196473 | 0.1 | 0.2 |
| Sulphate (SO4) | | | | | | |
| Nutrients | | | | | | |
| Dissolved | 0.130 | mg/L | IC/UV | 197179 | 0.003 | 0.006 |
| Nitrate (N) | | | | | | |
| Nitrate plus | 0.160 | mg/L | CALC | 196408 | 0.003 | 0.006 |
| Nitrite (N) | | | | | | |
| Dissolved | 0.030 | mg/L | IC/UV | 197179 | 0.003 | 0.006 |
| Nitrite (N) | | | | | | |
| Physical | | | | | | |
| Properties | | | | | | |
| Turbidity | 2670 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.
Anion-Cation balance is lower than our normal limits: major ions checked, possibly due to matrix.

| | | | |
|---|---|---|---|
| Sample | FW-B#1, RAW | Maxxam Sample | 355477 |
| Description | | Number | |
| Sample | | Maxxam Job | CA211074 |
| Date & Time | | Number | |
| Sampled By | | Sample Access | |
| Sample | Grab | Sample Matrix | WATER |
| Type | | | |
| Sample | Sep. 23, 2002 | Report Date | Sep. 27, 2002 |
| Received Date | | | |
| Sample Station | | | |
| Code | | | |

Elements by Atomic
Spectroscopy

| | | | | | | |
|---|---|---|---|---|---|---|
| PARAMETER | | | | QA/QC | | |
| DESCRIPTION | RESULTS | Units | INST. | Batch | MDL | RDL |

Elements

| | | | | | | |
|---|---|---|---|---|---|---|
| Total Aluminum (Al) | 25.3 | mg/L | ICPM | 196777 | 0.001 | 0.002 |
| Total Antimony (Sb) | 0.0038 | mg/L | ICPM | 196777 | 0.0002 | 0.0004 |
| Total Arsenic (As) | 0.028 | mg/L | ICPM | 196777 | 0.005 | 0.01 |
| Total Barium (Ba) | 4.06 | mg/L | ICPM | 196777 | 0.0002 | 0.0004 |
| Total Beryllium (Be) | 0.0017 | mg/L | ICPM | 196777 | 0.0002 | 0.0004 |
| Total Boron (B) | 6.76 | mg/L | ICPM | 196777 | 0.01 | 0.02 |
| Total Cadmium (Cd) | 0.0009 | mg/L | ICPM | 196777 | 0.0002 | 0.0004 |
| Total Calcium (Ca) | 92.8 | mg/L | ICPA | 196744 | 0.3 | 0.6 |
| Total Chromium (Cr) | 1.05 | mg/L | ICPM | 196777 | 0.001 | 0.002 |
| Total Cobalt (Co) | 0.0261 | mg/L | ICPM | 196777 | 0.0003 | 0.0006 |
| Total Copper (Cu) | 0.743 | mg/L | ICPM | 196777 | 0.0002 | 0.0004 |
| Total Iron (Fe) | 213 | mg/L | ICPA | 196744 | 0.01 | 0.02 |
| Total Lead (Pb) | 0.836 | mg/L | ICPM | 196777 | 0.0003 | 0.0006 |
| Total Lithium (Li) | 0.143 | mg/L | ICPA | 196744 | 0.004 | 0.008 |
| Total Magnesium (Mg) | 26.8 | mg/L | ICPA | 196744 | 0.2 | 0.4 |
| Total Manganese (Mn) | 2.81 | mg/L | ICPA | 196744 | 0.004 | 0.008 |
| Total Molybdenum (Mo) | 0.329 | mg/L | ICPM | 196777 | 0.0002 | 0.0004 |
| Total Nickel (Ni) | 0.252 | mg/L | ICPM | 196777 | 0.0005 | 0.001 |
| Total Phosphorus (P) | 1.7 | mg/L | ICPA | 196744 | 0.1 | 0.2 |
| Total Potassium (K) | 18.2 | mg/L | ICPA | 196744 | 0.3 | 0.6 |
| Total Selenium (Se) | <0.007 | mg/L | ICPM | 196777 | 0.007 | 0.014 |
| Total Silicon (Si) | 26.2 | mg/L | ICPA | 196744 | 0.04 | 0.08 |
| Total Silver (Ag) | 0.0004 | mg/L | ICPM | 196777 | 0.0001 | 0.0002 |
| Total Sodium (Na) | 1170 | mg/L | ICPA | 196744 | 0.5 | 1 |
| Total Strontium (Sr) | 2.01 | mg/L | ICPA | 196744 | 0.004 | 0.008 |
| Total Sulphur (S) | 26.0 | mg/L | ICPA | 196744 | 0.2 | 0.4 |
| Total Thallium (Tl) | (0.0003) | mg/L | ICPM | 196777 | 0.0002 | 0.0004 |
| Total Tin (Sn) | 0.020 | mg/L | ICPM | 196777 | 0.001 | 0.002 |
| Total Titanium (Ti) | 19.0 | mg/L | ICPM | 196777 | 0.001 | 0.002 |
| Total Uranium (U) | 0.0025 | mg/L | ICPM | 196777 | 0.0004 | 0.0008 |
| Total Vanadium (V) | 0.107 | mg/L | ICPM | 196777 | 0.001 | 0.002 |
| Elements | | | | | | |
| Total Zinc (Zn) | 10.3 | mg/L | ICPM | 196777 | 0.0006 | 0.0012 |
| Total Zirconium (Zr) | 0.112 | mg/L | ICPM | 196777 | 0.0002 | 0.0004 |
| Cations | | | | | | |
| Dissolved Calcium | 90.9 | mg/L | ICPA | 197317 | 0.3 | 0.6 |
| (Ca) | | | | | | |
| Dissolved Magnesium | 25.4 | mg/L | ICPA | 197317 | 0.2 | 0.4 |
| (Mg) | | | | | | |
| Dissolved Potassium | 14.3 | mg/L | ICPA | 197317 | 0.3 | 0.6 |
| (K) | | | | | | |
| Dissolved Sodium | 1140 | mg/L | ICPA | 197317 | 0.5 | 1 |
| (Na) | | | | | | |
| Dissolved Iron (Fe) | 135 | mg/L | ICPA | 197317 | 0.01 | 0.02 |
| Dissolved Manganese | 2.75 | mg/L | ICPA | 197317 | 0.004 | 0.008 |
| (Mn) | | | | | | |

MDL = Method Detection Limit - Calculated on the basis of the instrument detection level, the dilution used, and the weight of the sample.
RDL = Reliable Detection Limit (2 × MDL)
( ) = Result < RDL and is subject to reduced levels of confidence
Results are not corrected for surrogate or moisture values unless otherwise stated.

| | | | |
|---|---|---|---|
| Sample | FW-B#1, DLPC-1 | Maxxam Sample | 355475 |
| Description | | Number | |
| Sample | | Maxxam Job | CA211074 |
| Date & Time | | Number | |
| Sampled By | | Sample Access | |
| Sample | Grab | Sample Matrix | WATER |
| Type | | | |
| Sample | Sep. 23, 2002 | Report Date | Sep. 27, 2002 |
| Received Date | | | |
| Sample | | | |
| Station Code | | | |

TEST RESULTS ON FIRST FRAC WATER SAMPLE
AFTER SINGLE CLARIFICATION STEP

| | | | | | | |
|---|---|---|---|---|---|---|
| PARAMETER | | | | QA/QC | | |
| DESCRIPTION | RESULTS | Units | INST. | Batch | MDL | RDL |

Calculated
Parameters

| | | | | | | |
|---|---|---|---|---|---|---|
| Anion Sum | 101 | meq/L | CALC | 196406 | N/A | N/A |
| Cation Sum | 110 | meq/L | CALC | 196406 | N/A | N/A |
| Hardness | 2900 | mg/L | CALC | 196402 | 0.5 | 1 |
| (CaCO3) | | | | | | |
| Ion Balance | 1.09 | N/A | CALC | 196404 | 0.01 | 0.02 |
| Misc. | | | | | | |
| Inorganics | | | | | | |
| Conductivity | 12500 | uS/cm | ECEL | 196519 | 0.02 | 0.04 |
| pH | 7.06 | N/A | TITR/ALK | 196522 | N/A | N/A |
| Anions | | | | | | |
| Alkalinity | <0.5 | mg/L | TITR/ALK | 196515 | 0.5 | 1 |
| (PP as CaCO3) | | | | | | |
| Alkalinity | 134 | mg/L | TITR/ALK | 196515 | 0.5 | 1 |
| (Total as CaCO3) | | | | | | |
| Bicarbonate | 163 | mg/L | TITR/ALK | 196515 | 0.5 | 1 |
| (HCO3) | | | | | | |
| Carbonate | <0.5 | mg/L | TITR/ALK | 196515 | 0.5 | 1 |
| (CO3) | | | | | | |
| Dissolved | 3460 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide | <0.5 | mg/L | TITR/ALK | 196515 | 0.5 | 1 |
| (OH) | | | | | | |
| Dissolved | 12.9 | mg/L | IC/EC | 196473 | 0.1 | 0.2 |
| Sulphate (SO4) | | | | | | |
| Nutrients | | | | | | |
| Dissolved | 0.160 | mg/L | IC/UV | 196679 | 0.003 | 0.006 |
| Nitrate (N) | | | | | | |
| Nitrate plus | 0.187 | mg/L | CALC | 196408 | 0.003 | 0.006 |
| Nitrite (N) | | | | | | |
| Dissolved | 0.027 | mg/L | IC/UV | 196679 | 0.003 | 0.006 |
| Nitrite (N) | | | | | | |
| Physical | | | | | | |
| Properties | | | | | | |
| Turbidity | 57.5 | NTU | TURB | 196835 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#1, DLPC-1 | Maxxam Sample | 355475 |
| Description | | Number | |
| Sample | | Maxxam Job | CA211074 |
| Date & Time | | Number | |
| Sampled By | | Sample Access | |
| Sample | Grab | Sample Matrix | WATER |
| Type | | | |
| Sample | Sep. 23, 2002 | Report Date | Sep. 27, 2002 |
| Received Date | | | |
| Sample | | | |
| Station Code | | | |

Elements by Atomic
Spectroscopy

| | | | | | | |
|---|---|---|---|---|---|---|
| PARAMETER | | | | QA/QC | | |
| DESCRIPTION | RESULTS | Units | INST. | Batch | MDL | RDL |

Elements

| | | | | | | |
|---|---|---|---|---|---|---|
| Total | 0.146 | mg/L | ICPM | 196777 | 0.001 | 0.002 |
| Aluminum (Al) | | | | | | |
| Total | 0.0012 | mg/L | ICPM | 196777 | 0.0002 | 0.0004 |
| Antimony (Sb) | | | | | | |
| Total | <0.005 | mg/L | ICPM | 196777 | 0.005 | 0.01 |
| Arsenic (As) | | | | | | |
| Total | 1.81 | mg/L | ICPM | 196777 | 0.0002 | 0.0004 |
| Barium (Ba) | | | | | | |
| Total | 0.0002 | mg/L | ICPM | 196777 | 0.0002 | 0.0004 |
| Beryllium (Be) | | | | | | |
| Total | 5.42 | mg/L | ICPM | 196777 | 0.01 | 0.02 |
| Boron (B) | | | | | | |
| Total | <(0.0002) | mg/L | ICPM | 196777 | 0.0002 | 0.0004 |
| Cadmium (Cd) | | | | | | |
| Total | 1140 | mg/L | ICPA | 196744 | 0.3 | 0.6 |
| Calcium (Ca) | | | | | | |
| Total | 0.013 | mg/L | ICPM | 196777 | 0.001 | 0.002 |
| Chromium (Cr) | | | | | | |
| Total | 0.0065 | mg/L | ICPM | 196777 | 0.0003 | 0.0006 |
| Cobalt (Co) | | | | | | |
| Total | 0.0089 | mg/L | ICPM | 196777 | 0.0002 | 0.0004 |
| Copper (Cu) | | | | | | |
| Total | 5.59 | mg/L | ICPA | 196744 | 0.01 | 0.02 |
| Iron (Fe) | | | | | | |
| Total | (0.0004) | mg/L | ICPM | 196777 | 0.0003 | 0.0006 |
| Lead (Pb) | | | | | | |
| Total | 0.098 | mg/L | ICPA | 196744 | 0.004 | 0.008 |
| Lithium (Li) | | | | | | |
| Total | 15.8 | mg/L | ICPA | 196744 | 0.2 | 0.4 |
| Magnesium (Mg) | | | | | | |
| Total | 1.09 | mg/L | ICPA | 196744 | 0.004 | 0.008 |
| Manganese (Mn) | | | | | | |
| Total | 0.0041 | mg/L | ICPM | 196777 | 0.0002 | 0.0004 |
| Molybdenum (Mo) | | | | | | |
| Total | 0.0808 | mg/L | ICPM | 196777 | 0.0005 | 0.001 |
| Nickel (Ni) | | | | | | |
| Total | <0.1 | mg/L | ICPA | 196744 | 0.1 | 0.2 |
| Phosphorus (P) | | | | | | |
| Total | 13.5 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 0.87 | mg/L | ICPA | 196744 | 0.04 | 0.08 |
| Silicon (Si) | | | | | | |
| Total | 0.0002 | mg/L | ICPM | 196777 | 0.0001 | 0.0002 |
| Silver (Ag) | | | | | | |
| Total | 1190 | mg/L | ICPA | 196744 | 0.5 | 1 |
| Sodium (Na) | | | | | | |
| Total | 1.44 | mg/L | ICPA | 196744 | 0.004 | 0.008 |
| Strontium (Sr) | | | | | | |
| Total | 4.4 | mg/L | ICPA | 196744 | 0.2 | 0.4 |
| Sulphur (S) | | | | | | |
| Total | 0.0008 | mg/L | ICPM | 196777 | 0.0002 | 0.0004 |
| Thallium (Tl) | | | | | | |
| Total | 0.004 | mg/L | ICPM | 196777 | 0.001 | 0.002 |
| Tin (Sn) | | | | | | |
| Total | 0.006 | mg/L | ICPM | 196777 | 0.001 | 0.002 |
| Titanium (Ti) | | | | | | |
| Total | <0.0004 | mg/L | ICPM | 196777 | 0.0004 | 0.0008 |
| Uranium (U) | | | | | | |
| Total | 0.002 | mg/L | ICPM | 196777 | 0.001 | 0.002 |
| Vanadium (V) | | | | | | |
| Elements | | | | | | |
| Total | 0.292 | mg/L | ICPM | 196777 | 0.0006 | 0.0012 |
| Zinc (Zn) | | | | | | |
| Total | 0.0030 | mg/L | ICPM | 196777 | 0.0002 | 0.0004 |
| Zirconium (Zr) | | | | | | |
| Cations | | | | | | |
| Dissolved | 1140 | mg/L | ICPA | 196746 | 0.3 | 0.6 |
| Calcium (Ca) | | | | | | |
| Dissolved | 15.6 | mg/L | ICPA | 196746 | 0.2 | 0.4 |
| Magnesium (Mg) | | | | | | |
| Dissolved | 11.7 | mg/L | ICPA | 196746 | 0.3 | 0.6 |
| Potassium (K) | | | | | | |
| Dissolved | 1180 | mg/L | ICPA | 196746 | 0.5 | 1 |
| Sodium (Na) | | | | | | |
| Dissolved | 1.23 | mg/L | ICPA | 196746 | 0.01 | 0.02 |
| Iron (Fe) | | | | | | |
| Dissolved | 1.07 | mg/L | ICPA | 196746 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
( ) = Result < RDL and is subject to reduced levels of confidence
Results are not corrected for surrogate or moisture values unless otherwise stated.

| | | | |
|---|---|---|---|
| Sample | FW-B#1, DLPC-2 | Maxxam Sample | 355476 |
| Description | | Number | |
| Sample | | Maxxam Job | CA211074 |
| Date & Time | | Number | |
| Sampled By | | Sample Access | |
| Sample | Grab | Sample Matrix | WATER |
| Type | | | |
| Sample | Sep. 23, 2002 | Report Date | Sep. 27, 2002 |
| Received Date | | | |
| Sample | | | |
| Station Code | | | |

TEST RESULTS ON FIRST FRAC WATER SAMPLE
AFTER SECOND CLARIFICATION STEP

| | | | | | | |
|---|---|---|---|---|---|---|
| PARAMETER | | | | QA/QC | | |
| DESCRIPTION | RESULTS | Units | INST. | Batch | MDL | RDL |

Calculated
Parameters

| | | | | | | |
|---|---|---|---|---|---|---|
| Anion Sum | 120 | meq/L | CALC | 196406 | N/A | N/A |
| Cation Sum | 131 | meq/L | CALC | 196406 | N/A | N/A |
| Hardness | 3900 | mg/L | CALC | 196402 | 0.5 | 1 |
| (CaCO3) | | | | | | |
| Ion Balance | 1.09 | N/A | CALC | 196404 | 0.01 | 0.02 |
| Misc. | | | | | | |
| Inorganics | | | | | | |
| Conductivity | 14300 | uS/cm | ECEL | 196519 | 0.02 | 0.04 |
| pH | 7.56 | N/A | TITR/ALK | 196522 | N/A | N/A |
| Anions | | | | | | |
| Alkalinity | <0.5 | mg/L | TITR/ALK | 196515 | 0.5 | 1 |
| (PP as CaCO3) | | | | | | |
| Alkalinity | 126 | mg/L | TITR/ALK | 196515 | 0.5 | 1 |
| (Total as CaCO3) | | | | | | |
| Bicarbonate | 154 | mg/L | TITR/ALK | 196515 | 0.5 | 1 |
| (HCO3) | | | | | | |
| Carbonate | <0.5 | mg/L | TITR/ALK | 196515 | 0.5 | 1 |
| (CO3) | | | | | | |
| Dissolved | 4170 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide | <0.5 | mg/L | TITR/ALK | 196515 | 0.5 | 1 |
| (OH) | | | | | | |
| Dissolved | 11.5 | mg/L | IC/EC | 196473 | 0.1 | 0.2 |
| Sulphate (SO4) | | | | | | |
| Nutrients | | | | | | |
| Dissolved | 0.164 | mg/L | IC/UV | 196679 | 0.003 | 0.006 |
| Nitrate (N) | | | | | | |
| Nitrate plus | 0.164 | mg/L | CALC | 196408 | 0.003 | 0.006 |
| Nitrite (N) | | | | | | |
| Dissolved | <0.003 | mg/L | IC/UV | 196679 | 0.003 | 0.006 |
| Nitrite (N) | | | | | | |
| Physical | | | | | | |
| Properties | | | | | | |
| Turbidity | 3.3 | NTU | TURB | 196835 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#1, DLPC-2 | Maxxam Sample | 355476 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

Elements by Atomic
Spectroscopy

| | | | | | | |
|---|---|---|---|---|---|---|
| PARAMETER | | | | QA/QC | | |
| DESCRIPTION | RESULTS | Units | INST. | Batch | MDL | RDL |

Elements

| | | | | | | |
|---|---|---|---|---|---|---|
| Total | 2.41 | mg/L | ICPM | 196777 | 0.001 | 0.002 |
| Aluminum (Al) | | | | | | |
| Total | 0.0010 | mg/L | ICPM | 196777 | 0.0002 | 0.0004 |
| Antimony (Sb) | | | | | | |
| Total | <0.005 | mg/L | ICPM | 196777 | 0.005 | 0.01 |
| Arsenic (As) | | | | | | |
| Total | 1.42 | mg/L | ICPM | 196777 | 0.0002 | 0.0004 |
| Barium (Ba) | | | | | | |
| Total | <0.0002 | mg/L | ICPM | 196777 | 0.0002 | 0.0004 |
| Beryllium (Be) | | | | | | |
| Total | 4.84 | mg/L | ICPM | 196777 | 0.01 | 0.02 |
| Boron (B) | | | | | | |
| Total | <0.0002 | mg/L | ICPM | 196777 | 0.0002 | 0.0004 |
| Cadmium (Cd) | | | | | | |
| Total | 1570 | mg/L | ICPA | 196744 | 0.3 | 0.6 |
| Calcium (Ca) | | | | | | |
| Total | 0.014 | mg/L | ICPM | 196777 | 0.001 | 0.002 |
| Chromium (Cr) | | | | | | |
| Total | 0.0032 | mg/L | ICPM | 196777 | 0.0003 | 0.0006 |
| Cobalt (Co) | | | | | | |
| Total | 0.0048 | mg/L | ICPM | 196777 | 0.0002 | 0.0004 |
| Copper (Cu) | | | | | | |
| Total | 0.32 | mg/L | ICPA | 196744 | 0.01 | 0.02 |
| Iron (Fe) | | | | | | |
| Total | <0.0003 | mg/L | ICPM | 196777 | 0.0003 | 0.0006 |
| Lead (Pb) | | | | | | |
| Total | 0.094 | mg/L | ICPA | 196744 | 0.004 | 0.008 |
| Lithium (Li) | | | | | | |
| Total | 15.4 | mg/L | ICPA | 196744 | 0.2 | 0.4 |
| Magnesium (Mg) | | | | | | |
| Total | 6.34 | mg/L | ICPA | 196744 | 0.004 | 0.008 |
| Manganese (Mn) | | | | | | |
| Total | 0.0045 | mg/L | ICPM | 196777 | 0.0002 | 0.0004 |
| Molybdenum (Mo) | | | | | | |
| Total | 0.0457 | mg/L | ICPM | 196777 | 0.0005 | 0.001 |
| Nickel (Ni) | | | | | | |
| Total | <0.1 | mg/L | ICPA | 196744 | 0.1 | 0.2 |
| Phosphorus (P) | | | | | | |
| Total | 22.0 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 0.40 | mg/L | ICPA | 196744 | 0.04 | 0.08 |
| Silicon (Si) | | | | | | |
| Total | (0.0001) | mg/L | ICPM | 196777 | 0.0001 | 0.0002 |
| Silver (Ag) | | | | | | |
| Total | 1220 | mg/L | ICPA | 196744 | 0.5 | 1 |
| Sodium (Na) | | | | | | |
| Total | 1.45 | mg/L | ICPA | 196744 | 0.004 | 0.008 |
| Strontium (Sr) | | | | | | |
| Total | 4.2 | mg/L | ICPA | 196744 | 0.2 | 0.4 |
| Sulphur (S) | | | | | | |
| Total | <0.0002 | mg/L | ICPM | 196777 | 0.0002 | 0.0004 |
| Thallium (Tl) | | | | | | |
| Total | 0.003 | mg/L | ICPM | 196777 | 0.001 | 0.002 |
| Tin (Sn) | | | | | | |
| Total | 0.004 | mg/L | ICPM | 196777 | 0.001 | 0.002 |
| Titanium (Ti) | | | | | | |
| Total | <0.0004 | mg/L | ICPM | 196777 | 0.0004 | 0.0008 |
| Uranium (U) | | | | | | |
| Total | 0.002 | mg/L | ICPM | 196777 | 0.001 | 0.002 |
| Vanadium (V) | | | | | | |
| Elements | | | | | | |
| Total | 0.0218 | mg/L | ICPM | 196777 | 0.0006 | 0.0012 |
| Zinc (Zn) | | | | | | |
| Total | 0.0020 | mg/L | ICPM | 196777 | 0.0002 | 0.0004 |
| Zirconium (Zr) | | | | | | |
| Cations | | | | | | |
| Dissolved | 1540 | mg/L | ICPA | 196746 | 0.3 | 0.6 |
| Calcium (Ca) | | | | | | |
| Dissolved | 15.4 | mg/L | ICPA | 196746 | 0.2 | 0.4 |
| Magnesium (Mg) | | | | | | |
| Dissolved | 20.9 | mg/L | ICPA | 196746 | 0.3 | 0.6 |
| Potassium (K) | | | | | | |
| Dissolved | 1200 | mg/L | ICPA | 196746 | 0.5 | 1 |
| Sodium (Na) | | | | | | |
| Dissolved | 0.02 | mg/L | ICPA | 196746 | 0.01 | 0.02 |
| Iron (Fe) | | | | | | |
| Dissolved | 6.24 | mg/L | ICPA | 196746 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
( ) = Result < RDL and is subject to reduced levels of confidence
Results are not corrected for surrogate or moisture values unless otherwise stated.

| | | | |
|---|---|---|---|
| Sample | FW-B#2, RAW | Maxxam Sample | 355480 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS ON SECOND
RAW FRAC WATER SAMPLE

| | | | | | | |
|---|---|---|---|---|---|---|
| PARAMETER | | | | QA/QC | | |
| DESCRIPTION | RESULTS | Units | INST. | Batch | MDL | RDL |

Calculated
Parameters

| | | | | | | |
|---|---|---|---|---|---|---|
| Anion Sum | 81.2 | meq/L | CALC | 196406 | N/A | N/A |
| Cation Sum | 78.0 | meq/L | CALC | 196406 | N/A | N/A |
| Hardness | 280 | mg/L | CALC | 196402 | 0.5 | 1 |
| (CaCO3) | | | | | | |
| Ion Balance | 0.96 | N/A | CALC | 196404 | 0.01 | 0.02 |
| Misc. | | | | | | |
| Inorganics | | | | | | |
| Conductivity | 8000 | uS/cm | ECEL | 196519 | 0.02 | 0.04 |
| pH | 7.92 | N/A | TITR/ALK | 196523 | N/A | N/A |
| Anions | | | | | | |
| Alkalinity | <0.5 | mg/L | TITR/ALK | 196516 | 0.5 | 1 |
| (PP as CaCO3) | | | | | | |
| Alkalinity | 2560 | mg/L | TITR/ALK | 196516 | 0.5 | 1 |
| (Total as CaCO3) | | | | | | |
| Bicarbonate | 3130 | mg/L | TITR/ALK | 196516 | 0.5 | 1 |
| (HCO3) | | | | | | |
| Carbonate (CO3) | <0.5 | mg/L | TITR/ALK | 196516 | 0.5 | 1 |
| Dissolved | 1010 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide (OH) | <0.5 | mg/L | TITR/ALK | 196516 | 0.5 | 1 |
| Dissolved | 70.3 | mg/L | IC/EC | 196473 | 0.1 | 0.2 |
| Sulphate (SO4) | | | | | | |
| Nutrients | | | | | | |
| Dissolved | <0.003 | mg/L | IC/UV | 197179 | 0.003 | 0.006 |
| Nitrate (N) | | | | | | |
| Nitrate plus | <0.003 | mg/L | CALC | 196408 | 0.003 | 0.006 |
| Nitrite (N) | | | | | | |
| Dissolved | <0.003 | mg/L | IC/UV | 197179 | 0.003 | 0.006 |
| Nitrite (N) | | | | | | |
| Physical | | | | | | |
| Properties | | | | | | |
| Turbidity | 4470 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#2, RAW | Maxxam Sample | 355480 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

Elements by Atomic
Spectroscopy

| | | | | | | |
|---|---|---|---|---|---|---|
| PARAMETER | | | | QA/QC | | |
| DESCRIPTION | RESULTS | Units | INST. | Batch | MDL | RDL |

Elements

| | | | | | | |
|---|---|---|---|---|---|---|
| Total | 142 | mg/L | ICPM | 196777 | 0.001 | 0.002 |
| Aluminum (Al) | | | | | | |
| Total | 0.0047 | mg/L | ICPM | 196777 | 0.0002 | 0.0004 |
| Antimony (Sb) | | | | | | |
| Total | 0.070 | mg/L | ICPM | 196777 | 0.005 | 0.01 |
| Arsenic (As) | | | | | | |
| Total | 5.90 | mg/L | ICPM | 196777 | 0.0002 | 0.0004 |
| Barium (Ba) | | | | | | |
| Total | 0.0042 | mg/L | ICPM | 196777 | 0.0002 | 0.0004 |
| Beryllium (Be) | | | | | | |
| Total | 27.0 | mg/L | ICPM | 196777 | 0.01 | 0.02 |
| Boron (B) | | | | | | |
| Total | 0.0025 | mg/L | ICPM | 196777 | 0.0002 | 0.0004 |
| Cadmium (Cd) | | | | | | |
| Total | 170 | mg/L | ICPA | 196744 | 0.3 | 0.6 |
| Calcium (Ca) | | | | | | |
| Total | 1.04 | mg/L | ICPM | 196777 | 0.001 | 0.002 |
| Chromium (Cr) | | | | | | |
| Total | 0.0695 | mg/L | ICPM | 196777 | 0.0003 | 0.0006 |
| Cobalt (Co) | | | | | | |
| Total | 2.52 | mg/L | ICPM | 196777 | 0.0002 | 0.0004 |
| Copper (Cu) | | | | | | |
| Total | 243 | mg/L | ICPA | 196744 | 0.01 | 0.02 |
| Iron (Fe) | | | | | | |
| Total | 4.49 | mg/L | ICPM | 196777 | 0.0003 | 0.0006 |
| Lead (Pb) | | | | | | |
| Total | 0.311 | mg/L | ICPA | 196744 | 0.004 | 0.008 |
| Lithium (Li) | | | | | | |
| Total | 41.1 | mg/L | ICPA | 196744 | 0.2 | 0.4 |
| Magnesium (Mg) | | | | | | |
| Total | 2.71 | mg/L | ICPA | 196744 | 0.004 | 0.008 |
| Manganese (Mn) | | | | | | |
| Total | 0.384 | mg/L | ICPM | 196777 | 0.0002 | 0.0004 |
| Molybdenum (Mo) | | | | | | |
| Total | 0.735 | mg/L | ICPM | 196777 | 0.0005 | 0.001 |
| Nickel (Ni) | | | | | | |
| Total | 3.3 | mg/L | ICPA | 196744 | 0.1 | 0.2 |
| Phosphorus (P) | | | | | | |
| Total | 26.7 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 4.99 | mg/L | ICPA | 196744 | 0.04 | 0.08 |
| Silicon (Si) | | | | | | |
| Total | 0.0015 | mg/L | ICPM | 196777 | 0.0001 | 0.0002 |
| Silver (Ag) | | | | | | |
| Total | 1790 | mg/L | ICPA | 196744 | 0.5 | 1 |
| Sodium (Na) | | | | | | |
| Total | 2.56 | mg/L | ICPA | 196744 | 0.004 | 0.008 |
| Strontium (Sr) | | | | | | |
| Total | 50.8 | mg/L | ICPA | 196744 | 0.2 | 0.4 |
| Sulphur (S) | | | | | | |
| Total | 0.0009 | mg/L | ICPM | 196777 | 0.0002 | 0.0004 |
| Thallium (Tl) | | | | | | |
| Total Tin (Sn) | 0.065 | mg/L | ICPM | 196777 | 0.001 | 0.002 |
| Total | 14.0 | mg/L | ICPM | 196777 | 0.001 | 0.002 |
| Titanium (Ti) | | | | | | |
| Total | 0.0120 | mg/L | ICPM | 196777 | 0.0004 | 0.0008 |
| Uranium (U) | | | | | | |
| Total | 0.376 | mg/L | ICPM | 196777 | 0.001 | 0.002 |
| Vanadium (V) | | | | | | |
| Total Zinc (Zn) | 55.6 | mg/L | ICPM | 196777 | 0.0006 | 0.0012 |
| Elements | | | | | | |
| Total | 0.227 | mg/L | ICPM | 196777 | 0.0002 | 0.0004 |
| Zirconium (Zr) | | | | | | |
| Cations | | | | | | |
| Dissolved | 74.9 | mg/L | ICPA | 196746 | 0.3 | 0.6 |
| Calcium (Ca) | | | | | | |
| Dissolved | 22.9 | mg/L | ICPA | 196746 | 0.2 | 0.4 |
| Magnesium (Mg) | | | | | | |
| Dissolved | 13.3 | mg/L | ICPA | 196746 | 0.3 | 0.6 |
| Potassium (K) | | | | | | |
| Dissolved | 1660 | mg/L | ICPA | 196746 | 0.5 | 1 |
| Sodium (Na) | | | | | | |
| Dissolved | 9.44 | mg/L | ICPA | 196746 | 0.01 | 0.02 |
| Iron (Fe) | | | | | | |
| Dissolved | 1.00 | mg/L | ICPA | 196746 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#2, DLPC-1 | Maxxam Sample | 355478 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS ON SECOND FRAC WATER SAMPLE
AFTER SINGLE CLARIFICATION STEP

| | | | | | | |
|---|---|---|---|---|---|---|
| PARAMETER | | | | QA/QC | | |
| DESCRIPTION | RESULTS | Units | INST. | Batch | MDL | RDL |

Calculated
Parameters

| | | | | | | |
|---|---|---|---|---|---|---|
| Anion Sum | 94.7 | meq/L | CALC | 196406 | N/A | N/A |
| Cation Sum | 90.4 | meq/L | CALC | 196406 | N/A | N/A |
| Hardness | 460 | mg/L | CALC | 196402 | 0.5 | 1 |
| (CaCO3) | | | | | | |
| Ion Balance | 0.95 | N/A | CALC | 196404 | 0.01 | 0.02 |
| Misc. | | | | | | |
| Inorganics | | | | | | |
| Conductivity | 9870 | uS/cm | ECEL | 196519 | 0.02 | 0.04 |
| pH | 7.82 | N/A | TITR/ALK | 196523 | N/A | N/A |
| Anions | | | | | | |
| Alkalinity | <0.5 | mg/L | TITR/ALK | 196516 | 0.5 | 1 |
| (PP as CaCO3) | | | | | | |
| Alkalinity | 291 | mg/L | TITR/ALK | 196516 | 0.5 | 1 |
| (Total as CaCO3) | | | | | | |
| Bicarbonate | 355 | mg/L | TITR/ALK | 196516 | 0.5 | 1 |
| (HCO3) | | | | | | |
| Carbonate | <0.5 | mg/L | TITR/ALK | 196516 | 0.5 | 1 |
| (CO3) | | | | | | |
| Dissolved | 3100 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide (OH) | <0.5 | mg/L | TITR/ALK | 196516 | 0.5 | 1 |
| Dissolved | 64.2 | mg/L | IC/EC | 196473 | 0.1 | 0.2 |
| Sulphate (SO4) | | | | | | |
| Nutrients | | | | | | |
| Dissolved | <0.02 | mg/L | IC/UV | 197179 | 0.02 | 0.04 |
| Nitrate (N) | | | | | | |
| Nitrate plus | 0.250 | mg/L | CALC | 196408 | 0.003 | 0.006 |
| Nitrite (N) | | | | | | |
| Dissolved | 0.250 | mg/L | IC/UV | 197179 | 0.003 | 0.006 |
| Nitrite (N) | | | | | | |
| Physical | | | | | | |
| Properties | | | | | | |
| Turbidity | 22.8 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.
DETECTION LIMITS RAISED DUE TO MATRIX INTERFERENCE

| | | | |
|---|---|---|---|
| Sample | FW-B#2, DLPC-1 | Maxxam Sample | 355478 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

Elements by Atomic Spectroscopy

| PARAMETER | | | | QA/QC | | |
|---|---|---|---|---|---|---|
| DESCRIPTION | RESULTS | Units | INST. | Batch | MDL | RDL |
| Elements | | | | | | |
| Total | 1.56 | mg/L | ICPM | 196777 | 0.001 | 0.002 |
| Aluminum (Al) | | | | | | |
| Total | 0.0033 | mg/L | ICPM | 196777 | 0.0002 | 0.0004 |
| Antimony (Sb) | | | | | | |
| Total | <0.005 | mg/L | ICPM | 196777 | 0.005 | 0.01 |
| Arsenic (As) | | | | | | |
| Total | 0.175 | mg/L | ICPM | 196777 | 0.0002 | 0.0004 |
| Barium (Ba) | | | | | | |
| Total | <0.0002 | mg/L | ICPM | 196777 | 0.0002 | 0.0004 |
| Beryllium (Be) | | | | | | |
| Total | 13.7 | mg/L | ICPM | 196777 | 0.01 | 0.02 |
| Boron (B) | | | | | | |
| Total | <0.0002 | mg/L | ICPM | 196777 | 0.0002 | 0.0004 |
| Cadmium (Cd) | | | | | | |
| Total | 180 | mg/L | ICPA | 196744 | 0.3 | 0.6 |
| Calcium (Ca) | | | | | | |
| Total | 0.036 | mg/L | ICPM | 196777 | 0.001 | 0.002 |
| Chromium (Cr) | | | | | | |
| Total | 0.0007 | mg/L | ICPM | 196777 | 0.0003 | 0.0006 |
| Cobalt (Co) | | | | | | |
| Total | 0.0347 | mg/L | ICPM | 196777 | 0.0002 | 0.0004 |
| Copper (Cu) | | | | | | |
| Total | 0.67 | mg/L | ICPA | 196744 | 0.01 | 0.02 |
| Iron (Fe) | | | | | | |
| Total | 0.0147 | mg/L | ICPM | 196777 | 0.0003 | 0.0006 |
| Lead (Pb) | | | | | | |
| Total | 0.135 | mg/L | ICPA | 196744 | 0.004 | 0.008 |
| Lithium (Li) | | | | | | |
| Total | 6.6 | mg/L | ICPA | 196744 | 0.2 | 0.4 |
| Magnesium (Mg) | | | | | | |
| Total | 0.045 | mg/L | ICPA | 196744 | 0.004 | 0.008 |
| Manganese (Mn) | | | | | | |
| Total | 0.204 | mg/L | ICPM | 196777 | 0.0002 | 0.0004 |
| Molybdenum (Mo) | | | | | | |
| Total | 0.0267 | mg/L | ICPM | 196777 | 0.0005 | 0.001 |
| Nickel (Ni) | | | | | | |
| Total | <0.1 | mg/L | ICPA | 196744 | 0.1 | 0.2 |
| Phosphorus (P) | | | | | | |
| Total | 20.3 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 0.62 | mg/L | ICPA | 196744 | 0.04 | 0.08 |
| Silicon (Si) | | | | | | |
| Total | 0.0002 | mg/L | ICPM | 196777 | 0.0001 | 0.0002 |
| Silver (Ag) | | | | | | |
| Total | 1930 | mg/L | ICPA | 196744 | 0.5 | 1 |
| Sodium (Na) | | | | | | |
| Total | 0.286 | mg/L | ICPA | 196744 | 0.004 | 0.008 |
| Strontium (Sr) | | | | | | |
| Total | 29.5 | mg/L | ICPA | 196744 | 0.2 | 0.4 |
| Sulphur (S) | | | | | | |
| Total | <0.0002 | mg/L | ICPM | 196777 | 0.0002 | 0.0004 |
| Thallium (Tl) | | | | | | |
| Total | 0.011 | mg/L | ICPM | 196777 | 0.001 | 0.002 |
| Tin (Sn) | | | | | | |
| Total | 0.078 | mg/L | ICPM | 196777 | 0.001 | 0.002 |
| Titanium (Ti) | | | | | | |
| Total | <0.0004 | mg/L | ICPM | 196777 | 0.0004 | 0.0008 |
| Uranium (U) | | | | | | |
| Total | 0.003 | mg/L | ICPM | 196777 | 0.001 | 0.002 |
| Vanadium (V) | | | | | | |
| Total | 0.0929 | mg/L | ICPM | 196777 | 0.0006 | 0.0012 |
| Zinc (Zn) | | | | | | |
| Elements | | | | | | |
| Total | 0.0115 | mg/L | ICPM | 196777 | 0.0002 | 0.0004 |
| Zirconium (Zr) | | | | | | |
| Cations | | | | | | |
| Dissolved | 173 | mg/L | ICPA | 197317 | 0.3 | 0.6 |
| Calcium (Ca) | | | | | | |
| Dissolved | 5.5 | mg/L | ICPA | 197317 | 0.2 | 0.4 |
| Magnesium (Mg) | | | | | | |
| Dissolved | 20.0 | mg/L | ICPA | 197317 | 0.3 | 0.6 |
| Potassium (K) | | | | | | |
| Dissolved | 1860 | mg/L | ICPA | 197317 | 0.5 | 1 |
| Sodium (Na) | | | | | | |
| Dissolved | 0.36 | mg/L | ICPA | 197317 | 0.01 | 0.02 |
| Iron (Fe) | | | | | | |
| Dissolved | 0.034 | mg/L | ICPA | 196746 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#2, DLPC-2 | Maxxam Sample | 355479 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS ON SECOND FRAC WATER SAMPLE
AFTER SECOND CLARIFICATION STEP

| PARAMETER | | | | QA/QC | | |
|---|---|---|---|---|---|---|
| DESCRIPTION | RESULTS | Units | INST. | Batch | MDL | RDL |
| Calculated | | | | | | |
| Parameters | | | | | | |
| Anion Sum | 98.3 | meq/L | CALC | 196406 | N/A | N/A |
| Cation Sum | 95.7 | meq/L | CALC | 196406 | N/A | N/A |
| Hardness | 920 | mg/L | CALC | 196402 | 0.5 | 1 |
| (CaCO3) | | | | | | |
| Ion Balance | 0.97 | N/A | CALC | 196404 | 0.01 | 0.02 |
| Misc. | | | | | | |
| Inorganics | | | | | | |
| Conductivity | 11200 | uS/cm | ECEL | 196519 | 0.02 | 0.04 |
| pH | 7.52 | N/A | TITR/ALK | 196523 | N/A | N/A |
| Anions | | | | | | |
| Alkalinity | <0.5 | mg/L | TITR/ALK | 196516 | 0.5 | 1 |
| (PP as CaCO3) | | | | | | |
| Alkalinity | 174 | mg/L | TITR/ALK | 196516 | 0.5 | 1 |
| (Total as CaCO3) | | | | | | |
| Bicarbonate | 213 | mg/L | TITR/ALK | 196516 | 0.5 | 1 |
| (NCO3) | | | | | | |
| Carbonate | <0.5 | mg/L | TITR/ALK | 196516 | 0.5 | 1 |
| (CO3) | | | | | | |
| Dissolved | 3320 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide | <0.5 | mg/L | TITR/ALK | 196516 | 0.5 | 1 |
| (OH) | | | | | | |
| Dissolved | 52.4 | mg/L | IC/EC | 196473 | 0.1 | 0.2 |
| Sulphate (SO4) | | | | | | |
| Nutrients | | | | | | |
| Dissolved | 0.450 | mg/L | IC/UV | 197179 | 0.003 | 0.006 |
| Nitrate (N) | | | | | | |
| Nitrate plus | 0.450 | mg/L | CALC | 196408 | 0.003 | 0.006 |
| Nitrite (N) | | | | | | |
| Dissolved | <0.003 | mg/L | IC/UV | 197179 | 0.003 | 0.006 |
| Nitrite (N) | | | | | | |
| Physical | | | | | | |
| Properties | | | | | | |
| Turbidity | 10.2 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#2, DLPC-2 | Maxxam Sample | 355479 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

Elements by Atomic Spectroscopy

| PARAMETER | | | | QA/QC | | |
|---|---|---|---|---|---|---|
| DESCRIPTION | RESULTS | Units | INST. | Batch | MDL | RDL |
| Elements | | | | | | |
| Total | 9.85 | mg/L | ICPM | 196777 | 0.001 | 0.002 |
| Aluminum (Al) | | | | | | |
| Total | 0.0032 | mg/L | ICPM | 196777 | 0.0002 | 0.0004 |
| Antimony (Sb) | | | | | | |
| Total | <0.005 | mg/L | ICPM | 196777 | 0.005 | 0.01 |
| Arsenic (As) | | | | | | |
| Total | 0.121 | mg/L | ICPM | 196777 | 0.0002 | 0.0004 |
| Barium (Ba) | | | | | | |
| Total | <0.0002 | mg/L | ICPM | 196777 | 0.0002 | 0.0004 |
| Beryllium (Be) | | | | | | |
| Total | 16.9 | mg/L | ICPM | 196777 | 0.01 | 0.02 |
| Boron (B) | | | | | | |
| Total | (0.0002) | mg/L | ICPM | 196777 | 0.0002 | 0.0004 |
| Cadmium (Cd) | | | | | | |
| Total | 363 | mg/L | ICPA | 196744 | 0.3 | 0.6 |
| Calcium (Ca) | | | | | | |
| Total | 0.032 | mg/L | ICPM | 196777 | 0.001 | 0.002 |
| Chromium (Cr) | | | | | | |
| Total | 0.0010 | mg/L | ICPM | 196777 | 0.0003 | 0.0006 |
| Cobalt (Co) | | | | | | |
| Total | 0.0160 | mg/L | ICPM | 196777 | 0.0002 | 0.0004 |
| Copper (Cu) | | | | | | |
| Total | 0.19 | mg/L | ICPA | 196744 | 0.01 | 0.02 |
| Iron (Fe) | | | | | | |
| Total | 0.0009 | mg/L | ICPM | 196777 | 0.0003 | 0.0006 |
| Lead (Pb) | | | | | | |
| Total | 0.132 | mg/L | ICPA | 196744 | 0.004 | 0.008 |
| Lithium (Li) | | | | | | |
| Total | 4.5 | mg/L | ICPA | 196744 | 0.2 | 0.4 |
| Magnesium (Mg) | | | | | | |
| Total | 15.0 | mg/L | ICPA | 196744 | 0.004 | 0.008 |
| Manganese (Mn) | | | | | | |
| Total | 0.0670 | mg/L | ICPM | 196777 | 0.0002 | 0.0004 |
| Molybdenum (Mo) | | | | | | |
| Total | 0.0287 | mg/L | ICPM | 196777 | 0.0005 | 0.001 |
| Nickel (Ni) | | | | | | |
| Total | <0.1 | mg/L | ICPA | 196744 | 0.1 | 0.2 |
| Phosphorus (P) | | | | | | |
| Total | 33.9 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 0.39 | mg/L | ICPA | 196744 | 0.04 | 0.08 |
| Silicon (Si) | | | | | | |
| Total | 0.0002 | mg/L | ICPM | 196777 | 0.0001 | 0.0002 |
| Silver (Ag) | | | | | | |
| Total | 1800 | mg/L | ICPA | 196744 | 0.5 | 1 |
| Sodium (Na) | | | | | | |
| Total | 0.364 | mg/L | ICPA | 196744 | 0.004 | 0.008 |
| Strontium (Sr) | | | | | | |
| Total | 26.9 | mg/L | ICPA | 196744 | 0.2 | 0.4 |
| Sulphur (S) | | | | | | |
| Total | <0.0002 | mg/L | ICPM | 196777 | 0.0002 | 0.0004 |
| Thallium (Tl) | | | | | | |
| Total | 0.011 | mg/L | ICPM | 196777 | 0.001 | 0.002 |
| Tin (Sn) | | | | | | |
| Total | 0.008 | mg/L | ICPM | 196777 | 0.001 | 0.002 |
| Titanium (Ti) | | | | | | |
| Total | <0.0004 | mg/L | ICPM | 196777 | 0.0004 | 0.0008 |
| Uranium (U) | | | | | | |
| Total | 0.003 | mg/L | ICPM | 196777 | 0.001 | 0.002 |
| Vanadium (V) | | | | | | |
| Elements | | | | | | |
| Total | 0.0327 | mg/L | ICPM | 196777 | 0.0006 | 0.0012 |
| Zinc (Zn) | | | | | | |
| Total | 0.0069 | mg/L | ICPM | 196777 | 0.0002 | 0.0004 |
| Zirconium (Zr) | | | | | | |
| Cations | | | | | | |
| Dissolved | 363 | mg/L | ICPA | 196746 | 0.3 | 0.6 |
| Calcium (Ca) | | | | | | |
| Dissolved | 4.5 | mg/L | ICPA | 196746 | 0.2 | 0.4 |
| Magnesium (Mg) | | | | | | |
| Dissolved | 31.9 | mg/L | ICPA | 196746 | 0.3 | 0.6 |
| Potassium (K) | | | | | | |
| Dissolved | 1760 | mg/L | ICPA | 196746 | 0.5 | 1 |
| Sodium (Na) | | | | | | |
| Dissolved | <0.01 | mg/L | ICPA | 196746 | 0.01 | 0.02 |
| Iron (Fe) | | | | | | |
| Dissolved | 14.9 | mg/L | ICPA | 196746 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
( ) = Result < RDL and is subject to reduced levels of confidence
Results are not corrected for surrogate or moisture values unless otherwise stated.

| | | | |
|---|---|---|---|
| Sample | FW-8#3, RAW | Maxxam Sample | 355481 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS FOR THIRD
RAW FRAC WATER SAMPLE

| PARAMETER | | | | QA/QC | | |
|---|---|---|---|---|---|---|
| DESCRIPTION | RESULTS | Units | INST. | Batch | MDL | RDL |
| Calculated | | | | | | |
| Parameters | | | | | | |
| Anion Sum | 37.6 | meq/L | CALC | 196406 | N/A | N/A |
| Cation Sum | 71.3 | meq/L | CALC | 196406 | N/A | N/A |
| Hardness | 270 | mg/L | CALC | 196402 | 0.5 | 1 |
| (CaCO3) | | | | | | |
| Ion Balance | 1.90 | N/A | CALC | 196404 | 0.01 | 0.02 |
| Misc. | | | | | | |
| Inorganics | | | | | | |
| Conductivity | 2050 | uS/cm | ECEL | 196519 | 0.02 | 0.04 |
| pH | 7.80 | N/A | TITR/ALK | 196523 | N/A | N/A |
| Anions | | | | | | |
| Alkalinity | <0.5 | mg/L | TITR/ALK | 196516 | 0.5 | 1 |
| (PP as CaCO3) | | | | | | |
| Alkalinity | 726 | mg/L | TITR/ALK | 196516 | 0.5 | 1 |
| (Total as CaCO3) | | | | | | |
| Bicarbonate | 885 | mg/L | TITR/ALK | 196516 | 0.5 | 1 |
| (HCO3) | | | | | | |
| Carbonate | <0.5 | mg/L | TITR/ALK | 196516 | 0.5 | 1 |
| (CO3) | | | | | | |
| Dissolved | 776 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide | <0.5 | mg/L | TITR/ALK | 196516 | 0.5 | 1 |
| (OH) | | | | | | |
| Dissolved | 58.5 | mg/L | IC/EC | 196473 | 0.1 | 0.2 |
| Sulphate (SO4) | | | | | | |
| Nutrients | | | | | | |
| Dissolved | <0.02 | mg/L | IC/UV | 197179 | 0.02 | 0.04 |
| Nitrate (N) | | | | | | |
| Nitrate plus | <0.003 | mg/L | CALC | 196408 | 0.003 | 0.006 |
| Nitrite (N) | | | | | | |
| Dissolved | <0.2 | mg/L | IC/UV | 197179 | 0.2 | 0.4 |
| Nitrite (N) | | | | | | |
| Physical | | | | | | |
| Properties | | | | | | |
| Turbidity | 3990 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.
Anion-Cation balance is higher than our normal limits; major ions checked, possibly due to matrix.
DETECTION LIMITS RAISED DUE TO MATRIX INTERFERENCE

| | | | |
|---|---|---|---|
| Sample | FW-B#3, RAW | Maxxam Sample | 355481 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

Elements by Atomic Spectroscopy

| PARAMETER | | | | QA/QC | | |
|---|---|---|---|---|---|---|
| DESCRIPTION | RESULTS | Units | INST. | Batch | MDL | RDL |
| Elements | | | | | | |
| Total | 73.2 | mg/L | ICPM | 196777 | 0.001 | 0.002 |
| Aluminum (Al) | | | | | | |
| Total | 0.0046 | mg/L | ICPM | 196777 | 0.0002 | 0.0004 |
| Antimony (Sb) | | | | | | |
| Total | 0.056 | mg/L | ICPM | 196777 | 0.005 | 0.01 |
| Arsenic (As) | | | | | | |
| Total | 6.94 | mg/L | ICPM | 196777 | 0.0002 | 0.0004 |
| Barium (Ba) | | | | | | |
| Total | 0.0041 | mg/L | ICPM | 196777 | 0.0002 | 0.0004 |
| Beryllium (Be) | | | | | | |
| Total | 17.1 | mg/L | ICPM | 196777 | 0.01 | 0.02 |
| Boron (B) | | | | | | |
| Total | 0.0019 | mg/L | ICPM | 196777 | 0.0002 | 0.0004 |
| Cadmium (Cd) | | | | | | |
| Total | 94.0 | mg/L | ICPA | 196744 | 0.3 | 0.6 |
| Calcium (Ca) | | | | | | |
| Total | 0.975 | mg/L | ICPM | 196777 | 0.001 | 0.002 |
| Chromium (Cr) | | | | | | |
| Total | 0.0536 | mg/L | ICPM | 196777 | 0.0003 | 0.0006 |
| Cobalt (Co) | | | | | | |
| Total | 1.29 | mg/L | ICPM | 196777 | 0.0002 | 0.0004 |
| Copper (Cu) | | | | | | |
| Total | 191 | mg/L | ICPA | 196744 | 0.01 | 0.02 |
| Iron (Fe) | | | | | | |
| Total | 2.22 | mg/L | ICPM | 196777 | 0.0003 | 0.0006 |
| Lead (Pb) | | | | | | |
| Total | 0.286 | mg/L | ICPA | 196744 | 0.004 | 0.008 |
| Lithium (Li) | | | | | | |
| Total | 40.4 | mg/L | ICPA | 196744 | 0.2 | 0.4 |
| Magnesium (Mg) | | | | | | |
| Total | 1.76 | mg/L | ICPA | 196744 | 0.004 | 0.008 |
| Manganese (Mn) | | | | | | |
| Total | 0.342 | mg/L | ICPM | 196777 | 0.0002 | 0.0004 |
| Molybdenum (Mo) | | | | | | |
| Total | 0.532 | mg/L | ICPM | 196777 | 0.0005 | 0.001 |
| Nickel (Ni) | | | | | | |
| Total | 2.1 | mg/L | ICPA | 196744 | 0.1 | 0.2 |
| Phosphorus (P) | | | | | | |
| Total | 25.0 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 24.3 | mg/L | ICPA | 196744 | 0.04 | 0.08 |
| Silicon (Si) | | | | | | |
| Total | 0.0010 | mg/L | ICPM | 196777 | 0.0001 | 0.0002 |
| Silver (Ag) | | | | | | |
| Total | 1730 | mg/L | ICPA | 196744 | 0.5 | 1 |
| Sodium (Na) | | | | | | |
| Total | 2.03 | mg/L | ICPA | 196744 | 0.004 | 0.008 |
| Strontium (Sr) | | | | | | |
| Total | 32.5 | mg/L | ICPA | 196744 | 0.2 | 0.4 |
| Sulphur (S) | | | | | | |
| Total | 0.0009 | mg/L | ICPM | 196777 | 0.0002 | 0.0004 |
| Thallium (Tl) | | | | | | |
| Total | 0.041 | mg/L | ICPM | 196777 | 0.001 | 0.002 |
| Tin (Sn) | | | | | | |
| Total | 14.8 | mg/L | ICPM | 196777 | 0.001 | 0.002 |
| Titanium (Ti) | | | | | | |
| Total | 0.0086 | mg/L | ICPM | 196777 | 0.0004 | 0.0008 |
| Uranium (U) | | | | | | |
| Total | 0.444 | mg/L | ICPM | 196777 | 0.001 | 0.002 |
| Vanadium (V) | | | | | | |
| Total | 27.2 | mg/L | ICPM | 196777 | 0.0006 | 0.0012 |
| Zinc (Zn) | | | | | | |
| Elements | | | | | | |
| Total | 0.161 | mg/L | ICPM | 196777 | 0.0002 | 0.0004 |
| Zirconium (Zr) | | | | | | |
| Cations | | | | | | |
| Dissolved | 58.0 | mg/L | ICPA | 197317 | 0.3 | 0.6 |
| Calcium (Ca) | | | | | | |
| Dissolved | 29.4 | mg/L | ICPA | 197317 | 0.2 | 0.4 |
| Magnesium (Mg) | | | | | | |
| Dissolved | 15.1 | mg/L | ICPA | 197317 | 0.3 | 0.6 |
| Potassium (K) | | | | | | |
| Dissolved | 1510 | mg/L | ICPA | 197317 | 0.5 | 1 |
| Sodium (Na) | | | | | | |
| Dissolved | 23.9 | mg/L | ICPA | 197317 | 0.01 | 0.02 |
| Iron (Fe) | | | | | | |
| Dissolved | 0.329 | mg/L | ICPA | 197317 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#3, DLPC-1 | Maxxam Sample | 355482 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS FOR THIRD FRAC WATER SAMPLE
AFTER SINGLE CLARIFICATION STEP

| PARAMETER | | | | QA/QC | | |
|---|---|---|---|---|---|---|
| DESCRIPTION | RESULTS | Units | INST. | Batch | MDL | RDL |
| Calculated | | | | | | |
| Parameters | | | | | | |
| Anion Sum | 99.4 | meq/L | CALC | 196406 | N/A | N/A |
| Cation Sum | 104 | meq/L | CALC | 196406 | N/A | N/A |
| Hardness | 1400 | mg/L | CALC | 196402 | 0.5 | 1 |
| (CaCO3) | | | | | | |
| Ion Balance | 1.04 | N/A | CALC | 196404 | 0.01 | 0.02 |
| Misc. | | | | | | |
| Inorganics | | | | | | |
| Conductivity | 11500 | uS/cm | ECEL | 196519 | 0.02 | 0.04 |
| pH | 7.37 | N/A | TITR/ALK | 196523 | N/A | N/A |
| Anions | | | | | | |
| Alkalinity | <0.5 | mg/L | TITR/ALK | 196516 | 0.5 | 1 |
| (PP as CaCO3) | | | | | | |
| Alkalinity | 570 | mg/L | TITR/ALK | 196516 | 0.5 | 1 |
| (Total as CaCO3) | | | | | | |
| Bicarbonate | 696 | mg/L | TITR/ALK | 196516 | 0.5 | 1 |
| (HCO3) | | | | | | |
| Carbonate | <0.5 | mg/L | TITR/ALK | 196516 | 0.5 | 1 |
| (CO3) | | | | | | |
| Dissolved | 3080 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide | <0.5 | mg/L | TITR/ALK | 196516 | 0.5 | 1 |
| (OH) | | | | | | |
| Dissolved | 49.0 | mg/L | IC/EC | 196473 | 0.1 | 0.2 |
| Sulphate (SO4) | | | | | | |
| Nutrients | | | | | | |
| Dissolved | 0.133 | mg/L | IC/UV | 196679 | 0.003 | 0.006 |
| Nitrate (N) | | | | | | |
| Nitrate plus | 0.133 | mg/L | CALC | 196408 | 0.003 | 0.006 |
| Nitrite (N) | | | | | | |
| Dissolved | <0.003 | mg/L | IC/UV | 196679 | 0.003 | 0.006 |
| Nitrite (N) | | | | | | |
| Physical | | | | | | |
| Properties | | | | | | |
| Turbidity | 9.3 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample | FW-B#3, DLPC-1 | Maxxam Sample | 355482 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

Elements by Atomic Spectroscopy

| PARAMETER | | | | QA/QC | | |
|---|---|---|---|---|---|---|
| DESCRIPTION | RESULTS | Units | INST. | Batch | MDL | RDL |
| Elements | | | | | | |
| Total | 0.279 | mg/L | ICPM | 196777 | 0.001 | 0.002 |
| Aluminum (Al) | | | | | | |
| Total | 0.0028 | mg/L | ICPM | 196777 | 0.0002 | 0.0004 |
| Antimony (Sb) | | | | | | |
| Total | <0.005 | mg/L | ICPM | 196777 | 0.005 | 0.01 |
| Arsenic (As) | | | | | | |
| Total | 0.487 | mg/L | ICPM | 196777 | 0.0002 | 0.0004 |
| Barium (Ba) | | | | | | |
| Total | <0.0002 | mg/L | ICPM | 196777 | 0.0002 | 0.0004 |
| Beryllium (Be) | | | | | | |
| Total | 16.3 | mg/L | ICPM | 196777 | 0.01 | 0.02 |
| Boron (B) | | | | | | |
| Total | (0.0003) | mg/L | ICPM | 196777 | 0.0002 | 0.0004 |
| Cadmium (Cd) | | | | | | |
| Total | 528 | mg/L | ICPA | 196744 | 0.3 | 0.6 |
| Calcium (Ca) | | | | | | |
| Total | 0.020 | mg/L | ICPM | 196777 | 0.001 | 0.002 |
| Chromium (Cr) | | | | | | |
| Total | 0.0065 | mg/L | ICPM | 196777 | 0.0003 | 0.0006 |
| Cobalt (Co) | | | | | | |
| Total | 0.0281 | mg/L | ICPM | 196777 | 0.0002 | 0.0004 |
| Copper (Cu) | | | | | | |
| Total | 0.18 | mg/L | ICPA | 196744 | 0.01 | 0.02 |
| Iron (Fe) | | | | | | |
| Total | 0.0025 | mg/L | ICPM | 196777 | 0.0003 | 0.0006 |
| Lead (Pb) | | | | | | |
| Total | 0.170 | mg/L | ICPA | 196744 | 0.004 | 0.008 |
| Lithium (Li) | | | | | | |
| Total | 16.0 | mg/L | ICPA | 196744 | 0.2 | 0.4 |
| Magnesium (Mg) | | | | | | |
| Total | 0.586 | mg/L | ICPA | 196744 | 0.004 | 0.008 |
| Manganese (Mn) | | | | | | |
| Total | 0.0988 | mg/L | ICPM | 196777 | 0.0002 | 0.0004 |
| Molybdenum (Mo) | | | | | | |
| Total | 0.0986 | mg/L | ICPM | 196777 | 0.0005 | 0.001 |
| Nickel (Ni) | | | | | | |
| Total | <0.1 | mg/L | ICPA | 196744 | 0.1 | 0.2 |
| Phosphorus (P) | | | | | | |
| Total | 16.7 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 2.43 | mg/L | ICPA | 196744 | 0.04 | 0.08 |
| Silicon (Si) | | | | | | |
| Total | 0.0002 | mg/L | ICPM | 196777 | 0.0001 | 0.0002 |
| Silver (Ag) | | | | | | |
| Total | 1890 | mg/L | ICPA | 196744 | 0.5 | 1 |
| Sodium (Na) | | | | | | |
| Total | 1.12 | mg/L | ICPA | 196744 | 0.004 | 0.008 |
| Strontium (Sr) | | | | | | |
| Total | 22.4 | mg/L | ICPA | 196744 | 0.2 | 0.4 |
| Sulphur (S) | | | | | | |
| Total | <0.0002 | mg/L | ICPM | 196777 | 0.0002 | 0.0004 |
| Thallium (Tl) | | | | | | |
| Total | 0.008 | mg/L | ICPM | 196777 | 0.001 | 0.002 |
| Tin (Sn) | | | | | | |
| Total | 0.054 | mg/L | ICPM | 196777 | 0.001 | 0.002 |
| Titanium (Ti) | | | | | | |
| Total | <0.0004 | mg/L | ICPM | 196777 | 0.0004 | 0.0008 |
| Uranium (U) | | | | | | |
| Total | 0.004 | mg/L | ICPM | 196777 | 0.001 | 0.002 |
| Vanadium (V) | | | | | | |
| Elements | | | | | | |
| Total | 0.442 | mg/L | ICPM | 196777 | 0.0006 | 0.0012 |
| Zinc (Zn) | | | | | | |
| Total | 0.0012 | mg/L | ICPM | 196777 | 0.0002 | 0.0004 |
| Zirconium (Zr) | | | | | | |
| Cations | | | | | | |
| Dissolved | 523 | mg/L | ICPA | 196746 | 0.3 | 0.6 |
| Calcium (Ca) | | | | | | |
| Dissolved | 14.9 | mg/L | ICPA | 196746 | 0.2 | 0.4 |
| Magnesium (Mg) | | | | | | |
| Dissolved | 15.0 | mg/L | ICPA | 196746 | 0.3 | 0.6 |
| Potassium (K) | | | | | | |
| Dissolved | 1740 | mg/L | ICPA | 196746 | 0.5 | 1 |
| Sodium (Na) | | | | | | |
| Dissolved | 0.04 | mg/L | ICPA | 196746 | 0.01 | 0.02 |
| Iron (Fe) | | | | | | |
| Dissolved | 0.557 | mg/L | ICPA | 196746 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
( ) = Result < RDL and is subject to reduced levels of confidence
Results are not corrected for surrogate or moisture values unless otherwise stated.

| | | | |
|---|---|---|---|
| Sample | FW-B#3, DLPC-2 | Maxxam Sample | 355483 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS FOR THIRD FRAC WATER SAMPLE
AFTER SECOND CLARIFICATION STEP

| PARAMETER | | | | QA/QC | | |
|---|---|---|---|---|---|---|
| DESCRIPTION | RESULTS | Units | INST. | Batch | MDL | RDL |
| Calculated | | | | | | |
| Parameters | | | | | | |
| Anion Sum | 109 | meq/L | CALC | 196406 | N/A | N/A |
| Cation Sum | 117 | meq/L | CALC | 196406 | N/A | N/A |
| Hardness | 2000 | mg/L | CALC | 196402 | 0.5 | 1 |
| (CaCO3) | | | | | | |
| Ion Balance | 1.07 | N/A | CALC | 196404 | 0.01 | 0.02 |
| Misc. | | | | | | |
| Inorganics | | | | | | |
| Conductivity | 12900 | uS/cm | ECEL | 196519 | 0.02 | 0.04 |
| pH | 7.66 | N/A | TITR/ALK | 196523 | N/A | N/A |
| Anions | | | | | | |
| Alkalinity | <0.5 | mg/L | TITR/ALK | 196516 | 0.5 | 1 |
| (PP as CaCO3) | | | | | | |
| Alkalinity | 368 | mg/L | TITR/ALK | 196516 | 0.5 | 1 |
| (Total as CaCO3) | | | | | | |
| Bicarbonate | 448 | mg/L | TITR/ALK | 196516 | 0.5 | 1 |
| (HCO3) | | | | | | |
| Carbonate | <0.5 | mg/L | TITR/ALK | 196516 | 0.5 | 1 |
| (CO3) | | | | | | |
| Dissolved | 3580 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide | <0.5 | mg/L | TITR/ALK | 196516 | 0.5 | 1 |
| (OH) | | | | | | |
| Dissolved | 45.1 | mg/L | IC/EC | 196473 | 0.1 | 0.2 |
| Sulphate (SO4) | | | | | | |
| Nutrients | | | | | | |
| Dissolved | 0.140 | mg/L | IC/UV | 197179 | 0.003 | 0.006 |
| Nitrate (N) | | | | | | |
| Nitrate plus | 0.140 | mg/L | CALC | 196408 | 0.003 | 0.006 |
| Nitrite (N) | | | | | | |
| Dissolved | <0.2 | mg/L | IC/UV | 197179 | 0.2 | 0.4 |
| Nitrite (N) | | | | | | |
| Physical | | | | | | |
| Properties | | | | | | |
| Turbidity | 7.6 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.
DETECTION LIMITS RAISED DUE TO MATRIX INTERFERENCE

| | | | |
|---|---|---|---|
| Sample | FW-B#3, DLPC-2 | Maxxam Sample | 355483 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

Elements by Atomic Spectroscopy

| PARAMETER | | | | QA/QC | | |
|---|---|---|---|---|---|---|
| DESCRIPTION | RESULTS | Units | INST. | Batch | MDL | RDL |
| Elements | | | | | | |
| Total | 5.48 | mg/L | ICPM | 196777 | 0.001 | 0.002 |
| Aluminum (Al) | | | | | | |
| Total | 0.0020 | mg/L | ICPM | 196777 | 0.0002 | 0.0004 |
| Antimony (Sb) | | | | | | |
| Total | <0.005 | mg/L | ICPM | 196777 | 0.005 | 0.01 |
| Arsenic (As) | | | | | | |
| Total | 0.265 | mg/L | ICPM | 196777 | 0.0002 | 0.0004 |
| Barium (Ba) | | | | | | |
| Total | <0.0002 | mg/L | ICPM | 196777 | 0.0002 | 0.0004 |
| Beryllium (Be) | | | | | | |
| Total | 15.2 | mg/L | ICPM | 196777 | 0.01 | 0.02 |
| Boron (B) | | | | | | |
| Total | <0.0002 | mg/L | ICPM | 196777 | 0.0002 | 0.0004 |
| Cadmium (Cd) | | | | | | |
| Total | 761 | mg/L | ICPA | 196744 | 0.3 | 0.6 |
| Calcium (Ca) | | | | | | |
| Total | 0.024 | mg/L | ICPM | 196777 | 0.001 | 0.002 |
| Chromium (Cr) | | | | | | |
| Total | 0.0037 | mg/L | ICPM | 196777 | 0.0003 | 0.0006 |
| Cobalt (Co) | | | | | | |
| Total | 0.0124 | mg/L | ICPM | 196777 | 0.0002 | 0.0004 |
| Copper (Cu) | | | | | | |
| Total | 0.14 | mg/L | ICPA | 196744 | 0.01 | 0.02 |
| Iron (Fe) | | | | | | |
| Total | 0.0006 | mg/L | ICPM | 196777 | 0.0003 | 0.0006 |
| Lead (Pb) | | | | | | |
| Total | 0.163 | mg/L | ICPA | 196744 | 0.004 | 0.008 |
| Lithium (Li) | | | | | | |
| Total | 16.0 | mg/L | ICPA | 196744 | 0.2 | 0.4 |
| Magnesium (Mg) | | | | | | |
| Total | 5.57 | mg/L | ICPA | 196744 | 0.004 | 0.008 |
| Manganese (Mn) | | | | | | |
| Total | 0.0365 | mg/L | ICPM | 196777 | 0.0002 | 0.0004 |
| Molybdenum (Mo) | | | | | | |
| Total | 0.0672 | mg/L | ICPM | 196777 | 0.0005 | 0.001 |
| Nickel (Ni) | | | | | | |
| Total | <0.1 | mg/L | ICPA | 196744 | 0.1 | 0.2 |
| Phosphorus (P) | | | | | | |
| Total | 28.2 | mg/L | ICPA | 196744 | 0.3 | 0.6 |
| Potassium (K) | | | | | | |
| Total | <0.007 | mg/L | ICPM | 196777 | 0.007 | 0.014 |
| Selenium (Se) | | | | | | |
| Total | 1.42 | mg/L | ICPA | 196744 | 0.04 | 0.08 |
| Silicon (Si) | | | | | | |
| Total | 0.0002 | mg/L | ICPM | 196777 | 0.0001 | 0.0002 |
| Silver (Ag) | | | | | | |
| Total | 1820 | mg/L | ICPA | 196744 | 0.5 | 1 |
| Sodium (Na) | | | | | | |
| Total | 1.09 | mg/L | ICPA | 196744 | 0.004 | 0.008 |
| Strontium (Sr) | | | | | | |
| Total | 21.2 | mg/L | ICPA | 196744 | 0.2 | 0.4 |
| Sulphur (S) | | | | | | |
| Total | <0.0002 | mg/L | ICPM | 196777 | 0.0002 | 0.0004 |
| Thallium (Tl) | | | | | | |
| Total | 0.007 | mg/L | ICPM | 196777 | 0.001 | 0.002 |
| Tin (Sn) | | | | | | |
| Total | 0.016 | mg/L | ICPM | 196777 | 0.001 | 0.002 |
| Titanium (Ti) | | | | | | |
| Total | <0.0004 | mg/L | ICPM | 196777 | 0.0004 | 0.0008 |
| Uranium (U) | | | | | | |
| Total | 0.004 | mg/L | ICPM | 196777 | 0.001 | 0.002 |
| Vanadium (V) | | | | | | |
| Total | 0.0474 | mg/L | ICPM | 196777 | 0.0006 | 0.0012 |
| Zinc (Zn) | | | | | | |
| Elements | | | | | | |
| Total | 0.0033 | mg/L | ICPM | 196777 | 0.0002 | 0.0004 |
| Zirconium (Zr) | | | | | | |
| Cations | | | | | | |
| Dissolved | 761 | mg/L | ICPA | 196746 | 0.3 | 0.6 |
| Calcium (Ca) | | | | | | |
| Dissolved | 15.8 | mg/L | ICPA | 196746 | 0.2 | 0.4 |
| Magnesium (Mg) | | | | | | |
| Dissolved | 27.0 | mg/L | ICPA | 196746 | 0.3 | 0.6 |
| Potassium (K) | | | | | | |
| Dissolved | 1760 | mg/L | ICPA | 196746 | 0.5 | 1 |
| Sodium (Na) | | | | | | |
| Dissolved | (0.01) | mg/L | ICPA | 196746 | 0.01 | 0.02 |
| Iron (Fe) | | | | | | |
| Dissolved | 5.37 | mg/L | ICPA | 196746 | 0.004 | 0.008 |
| Manganese (Mn) | | | | | | |

MDL = Method Detection Limit - Calculated on the basis of the instrument detection level, the dilution used, and the weight of the sample.
RDL = Reliable Detection Limit (2 × MDL)
( ) = Result < RDL and is subject to reduced levels of confidence
Results are not corrected for surrogate or moisture values unless otherwise stated.

| | | | |
|---|---|---|---|
| Sample | FW-B#4, RAW | Maxxam Sample | 355484 |
| Description | | Number | |
| Sample | | Maxxam Job | CA211074 |
| Date & Time | | Number | |
| Sampled By | | Sample Access | |
| Sample Type | Grab | Sample Matrix | WATER |
| Sample | Sep. 23, 2002 | Report Date | Sep. 27, 2002 |
| Received Date | | | |
| Sample | | | |
| Station Code | | | |

TEST RESULTS ON FOURTH
RAW FRAC WATER SAMPLE

| PARAMETER | | | | QA/QC | | |
|---|---|---|---|---|---|---|
| DESCRIPTION | RESULTS | Units | INST. | Batch | MDL | RDL |
| Calculated | | | | | | |
| Parameters | | | | | | |
| Anion Sum | 47.6 | meq/L | CALC | 196406 | N/A | N/A |
| Cation Sum | 38.2 | meq/L | CALC | 196406 | N/A | N/A |
| Hardness | 270 | mg/L | CALC | 196402 | 0.5 | 1 |
| (CaCO3) | | | | | | |
| Ion Balance | 0.80 | N/A | CALC | 196404 | 0.01 | 0.02 |
| Misc. | | | | | | |
| Inorganics | | | | | | |
| Conductivity | 4640 | uS/cm | ECEL | 196519 | 0.02 | 0.04 |
| pH | 7.82 | N/A | TITR/ALK | 196523 | N/A | N/A |
| Anions | | | | | | |
| Alkalinity | <0.5 | mg/L | TITR/ALK | 196516 | 0.5 | 1 |
| (PP as CaCO3) | | | | | | |
| Alkalinity | 1450 | mg/L | TITR/ALK | 196516 | 0.5 | 1 |
| (Total as CaCO3) | | | | | | |
| Bicarbonate | 1770 | mg/L | TITR/ALK | 196516 | 0.5 | 1 |
| (HCO3) | | | | | | |
| Carbonate | <0.5 | mg/L | TITR/ALK | 196516 | 0.5 | 1 |
| (CO3) | | | | | | |
| Dissolved | 606 | mg/L | TECH/CL | 196427 | 0.5 | 1 |
| Chloride (Cl) | | | | | | |
| Dissolved | <0.05 | mg/L | | 196520 | 0.05 | 0.1 |
| Fluoride (F) | | | | | | |
| Hydroxide | <0.5 | mg/L | TITR/ALK | 196516 | 0.5 | 1 |
| (OH) | | | | | | |
| Dissolved | 73.3 | mg/L | IC/EC | 196473 | 0.1 | 0.2 |
| Sulphate (SO4) | | | | | | |
| Nutrients | | | | | | |
| Dissolved | 0.300 | mg/L | IC/UV | 197179 | 0.003 | 0.006 |
| Nitrate (N) | | | | | | |
| Nitrate plus | 0.300 | mg/L | CALC | 196408 | 0.003 | 0.006 |
| Nitrite (N) | | | | | | |
| Dissolved | <0.003 | mg/L | IC/UV | 197179 | 0.003 | 0.006 |
| Nitrite (N) | | | | | | |
| Physical | | | | | | |
| Properties | | | | | | |
| Turbidity | 3490 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.
Anion-Cation balance is lower than our normal limits; major ions checked, possibly due to matrix.

| | | | |
|---|---|---|---|
| Sample Description | FW-B#4, RAW | Maxxam Sample Number | 355484 |
| Sample Date & Time | | Maxxam Job Number | CA211074 |
| Sampled By | | Sample Access | |
| Sample Type | Grab | Sample Matrix | WATER |
| Sample Received Date | 2002/09/23 | Report Date | 2002/09/27 |
| Sample Station Code | | | |

Elements by Atomic Spectroscopy

| | | | | QA/QC | | |
|---|---|---|---|---|---|---|
| PARAMETER DESCRIPTION | RESULTS | Units | INST. | Batch | MDL | RDL |
| Elements | | | | | | |
| Total Aluminum (Al) | 37.3 | mg/L | ICPM | 196777 | 0.001 | 0.002 |
| Total Antimony (Sb) | 0.0077 | mg/L | ICPM | 196777 | 0.0002 | 0.0004 |
| Total Arsenic (As) | 0.029 | mg/L | ICPM | 196777 | 0.005 | 0.01 |
| Total Barium (Ba) | 4.49 | mg/L | ICPM | 196777 | 0.0002 | 0.0004 |
| Total Beryllium (Be) | 0.0016 | mg/L | ICPM | 196777 | 0.0002 | 0.0004 |
| Total Boron (B) | 8.95 | mg/L | ICPM | 196777 | 0.01 | 0.02 |
| Total Cadmium (Cd) | 0.0018 | mg/L | ICPM | 196777 | 0.0002 | 0.0004 |
| Total Calcium (Ca) | 266 | mg/L | ICPA | 196744 | 0.3 | 0.6 |
| Total Chromium (Cr) | 1.03 | mg/L | ICPM | 196777 | 0.001 | 0.002 |
| Total Cobalt (Co) | 0.0359 | mg/L | ICPM | 196777 | 0.0003 | 0.0006 |
| Total Copper (Cu) | 1.15 | mg/L | ICPM | 196777 | 0.0002 | 0.0004 |
| Total Iron (Fe) | 190 | mg/L | ICPA | 196744 | 0.01 | 0.02 |
| Total Lead (Pb) | 1.86 | mg/L | ICPM | 196777 | 0.0003 | 0.0006 |
| Total Lithium (Li) | 0.125 | mg/L | ICPA | 196744 | 0.004 | 0.008 |
| Total Magnesium (Mg) | 30.1 | mg/L | ICPA | 196744 | 0.2 | 0.4 |
| Total Manganese (Mn) | 2.54 | mg/L | ICPA | 196744 | 0.004 | 0.008 |
| Total Molybdenum (Mo) | 0.343 | mg/L | ICPM | 196777 | 0.0002 | 0.0004 |
| Total Nickel (Ni) | 0.376 | mg/L | ICPM | 196777 | 0.0005 | 0.001 |
| Total Phosphorus (P) | 1.7 | mg/L | ICPA | 196744 | 0.1 | 0.2 |
| Total Potassium (K) | 15.3 | mg/L | ICPA | 196744 | 0.3 | 0.6 |
| Total Selenium (Se) | <0.007 | mg/L | ICPM | 196777 | 0.007 | 0.014 |
| Total Silicon (Si) | 39.4 | mg/L | ICPA | 196744 | 0.04 | 0.08 |
| Total Silver (Ag) | 0.0006 | mg/L | ICPM | 196777 | 0.0001 | 0.0002 |
| Total Sodium (Na) | 869 | mg/L | ICPA | 196744 | 0.5 | 1 |
| Total Strontium (Sr) | 1.92 | mg/L | ICPA | 196744 | 0.004 | 0.008 |
| Total Sulphur(S) | 28.9 | mg/L | ICPA | 196744 | 0.2 | 0.4 |
| Total Thallium (Tl) | 0.0005 | mg/L | ICPM | 196777 | 0.0002 | 0.0004 |
| Total Tin (Sn) | 0.023 | mg/L | ICPM | 196777 | 0.001 | 0.002 |
| Total Titanium (Ti) | 17.8 | mg/L | ICPM | 196777 | 0.001 | 0.002 |
| Total Uranium (U) | 0.0042 | mg/L | ICPM | 196777 | 0.0004 | 0.0008 |
| Total Vanadium (V) | 0.121 | mg/L | ICPM | 196777 | 0.001 | 0.002 |
| Total Zinc (Zn) | 42.1 | mg/L | ICPM | 196777 | 0.0006 | 0.0012 |
| Elements | | | | | | |
| Total Zirconium (Zr) | 0.0940 | mg/L | ICPM | 196777 | 0.0002 | 0.0004 |
| Cations | | | | | | |
| Dissolved Calcium (Ca) | 73.2 | mg/L | ICPA | 197317 | 0.3 | 0.6 |
| Dissolved Magnesium (Mg) | 22.1 | mg/L | ICPA | 197317 | 0.2 | 0.4 |
| Dissolved Potassium (K) | 11.5 | mg/L | ICPA | 197317 | 0.3 | 0.6 |
| Dissolved Sodium (Na) | 746 | mg/L | ICPA | 197317 | 0.5 | 1 |
| Dissolved Iron (Fe) | 88.5 | mg/L | ICPA | 197317 | 0.01 | 0.02 |
| Dissolved Manganese (Mn) | 1.76 | mg/L | ICPA | 197317 | 0.004 | 0.008 |

MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample Description | FW-B#4, DLPC-1 | Maxxam Sample Number | 355485 |
| Sample Date & Time | | Maxxam Job Number | CA211074 |
| Sampled By | | Sample Access | |
| Sample Type | Grab | Sample Matrix | WATER |
| Sample Received Date | 2002/09/23 | Report Date | 2002/09/27 |
| Sample Station Code | | | |

TEST RESULTS ON FOURTH FRAC WATER SAMPLE
AFTER SINGLE CLARIFICATION STEP

| | | | | QA/QC | | |
|---|---|---|---|---|---|---|
| PARAMETER DESCRIPTION | RESULTS | Units | INST. | Batch | MDL | RDL |
| Calculated Parameters | | | | | | |
| Anion Sum | 89.5 | meq/L | CALC | 196406 | N/A | N/A |
| Cation Sum | 81.3 | meq/L | CALC | 196406 | N/A | N/A |
| Hardness (CaCO3) | 2300 | mg/L | CALC | 196402 | 0.5 | 1 |
| Ion Balance | 0.91 | N/A | CALC | 196404 | 0.01 | 0.02 |
| Misc. Inorganics | | | | | | |
| Conductivity | 9920 | uS/cm | ECEL | 196519 | 0.02 | 0.04 |
| pH | 6.74 | N/A | TITR/ALK | 196523 | N/A | N/A |
| Anions | | | | | | |
| Alkalinity (PP as CaCO3) | <0.5 | mg/L | TITR/ALK | 196516 | 0.5 | 1 |
| Alkalinity (Total as CaCO3) | 19.3 | mg/L | TITR/ALK | 196516 | 0.5 | 1 |
| Bicarbonate (HCO3) | 23.5 | mg/L | TITR/ALK | 196516 | 0.5 | 1 |
| Carbonate (CO3) | <0.5 | mg/L | TITR/ALK | 196516 | 0.5 | 1 |
| Dissolved Chloride (Cl) | 3160 | mg/L | TECH/CL | 196427 | 0.5 | 1 |
| Dissolved Fluoride (F) | <0.05 | mg/L | | 196520 | 0.05 | 0.1 |
| Hydroxide (OH) | <0.5 | mg/L | TITR/ALK | 196516 | 0.5 | 1 |
| Dissolved Sulphate (SO4) | 5.3 | mg/L | IC/EC | 196555 | 0.1 | 0.2 |
| Nutrients | | | | | | |
| Dissolved Nitrate (N) | 0.158 | mg/L | IC/UV | 196679 | 0.003 | 0.006 |
| Nitrate plus Nitrite (N) | 0.208 | mg/L | CALC | 196408 | 0.003 | 0.006 |
| Dissolved Nitrite (N) | 0.050 | mg/L | IC/UV | 196679 | 0.003 | 0.006 |
| Physical Properties | | | | | | |
| Turbidity | 69.0 | NTU | TURB | 197100 | 0.1 | 0.2 |

N/A = Not Applicable
MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample Description | FW-B#4, DLPC-1 | Maxxam Sample Number | 355485 |
| Sample Date & Time | | Maxxam Job Number | CA211074 |
| Sampled By | | Sample Access | |
| Sample Type | Grab | Sample Matrix | WATER |
| Sample Received Date | 2002/09/23 | Report Date | 2002/09/27 |
| Sample Station Code | | | |

Elements by Atomic Spectroscopy

| | | | | QA/QC | | |
|---|---|---|---|---|---|---|
| PARAMETER DESCRIPTION | RESULTS | Units | INST. | Batch | MDL | RDL |
| Elements | | | | | | |
| Total Aluminum (Al) | 50.5 | mg/L | ICPM | 196777 | 0.001 | 0.002 |
| Total Antimony (Sb) | 0.0006 | mg/L | ICPM | 196777 | 0.0002 | 0.0004 |
| Total Arsenic (As) | <0.005 | mg/L | ICPM | 196777 | 0.005 | 0.01 |
| Total Barium (Ba) | 1.31 | mg/L | ICPM | 196777 | 0.0002 | 0.0004 |
| Total Beryllium (Be) | <0.0002 | mg/L | ICPM | 196777 | 0.0002 | 0.0004 |
| Total Boron (B) | 3.31 | mg/L | ICPM | 196777 | 0.01 | 0.02 |
| Total Cadmium (Cd) | <0.0002 | mg/L | ICPM | 196777 | 0.0002 | 0.0004 |
| Total Calcium (Ca) | 932 | mg/L | ICPA | 196744 | 0.3 | 0.6 |
| Total Chromium (Cr) | 0.029 | mg/L | ICPM | 196777 | 0.001 | 0.002 |
| Total Cobalt (Co) | 0.0016 | mg/L | ICPM | 196777 | 0.0003 | 0.0006 |
| Total Copper (Cu) | 0.0271 | mg/L | ICPM | 196777 | 0.0002 | 0.0004 |
| Total Iron (Fe) | 1.54 | mg/L | ICPA | 196744 | 0.01 | 0.02 |
| Total Lead (Pb) | 0.0162 | mg/L | ICPM | 196777 | 0.0003 | 0.0006 |
| Total Lithium (Li) | 0.067 | mg/L | ICPA | 196744 | 0.004 | 0.008 |
| Total Magnesium (Mg) | 4.6 | mg/L | ICPA | 196744 | 0.2 | 0.4 |
| Total Manganese (Mn) | 0.081 | mg/L | ICPA | 196744 | 0.004 | 0.008 |
| Total Molybdenum (Mo) | 0.0365 | mg/L | ICPM | 196777 | 0.0002 | 0.0004 |
| Total Nickel (Ni) | 0.0239 | mg/L | ICPM | 196777 | 0.0005 | 0.001 |
| Total Phosphorus (P) | <0.1 | mg/L | ICPA | 196744 | 0.1 | 0.2 |
| Total Potassium (K) | 11.8 | mg/L | ICPA | 196744 | 0.3 | 0.6 |
| Total Selenium (Se) | <0.007 | mg/L | ICPM | 196777 | 0.007 | 0.014 |
| Total Silicon (Si) | 0.46 | mg/L | ICPA | 196744 | 0.04 | 0.08 |
| Total Silver (Ag) | 0.0003 | mg/L | ICPM | 196777 | 0.0001 | 0.0002 |
| Total Sodium (Na) | 853 | mg/L | ICPA | 196744 | 0.5 | 1 |
| Total Strontium (Sr) | 0.878 | mg/L | ICPA | 196744 | 0.004 | 0.008 |
| Total Sulphur (S) | 3.7 | mg/L | ICPA | 196744 | 0.2 | 0.4 |
| Total Thallium (Tl) | <0.0002 | mg/L | ICPM | 196777 | 0.0002 | 0.0004 |
| Total Tin (Sn) | 0.006 | mg/L | ICPM | 196777 | 0.001 | 0.002 |
| Total Titanium (Ti) | 0.226 | mg/L | ICPM | 196777 | 0.001 | 0.002 |
| Total Uranium (U) | <0.0004 | mg/L | ICPM | 196777 | 0.0004 | 0.0008 |
| Total Vanadium (V) | 0.003 | mg/L | ICPM | 196777 | 0.001 | 0.002 |
| Total Zinc (Zn) | 0.194 | mg/L | ICPM | 196777 | 0.0006 | 0.0012 |
| Total Zirconium (Zr) | 0.0009 | mg/L | ICPM | 196777 | 0.0002 | 0.0004 |
| Cations | | | | | | |
| Dissolved Calcium (Ca) | 905 | mg/L | ICPA | 196746 | 0.3 | 0.6 |
| Dissolved Magnesium (Mg) | 4.5 | mg/L | ICPA | 196746 | 0.2 | 0.4 |
| Dissolved Potassium (K) | 11.1 | mg/L | ICPA | 196746 | 0.3 | 0.6 |
| Dissolved Sodium (Na) | 816 | mg/L | ICPA | 196746 | 0.5 | 1 |
| Dissolved Iron (Fe) | 0.02 | mg/L | ICPA | 196746 | 0.01 | 0.02 |
| Dissolved Manganese (Mn) | 0.073 | mg/L | ICPA | 196746 | 0.004 | 0.008 |

MDL = Method Detection Limit - Calculated on the basis of the instrument detection level, the dilution used, and the weight of the sample.
RDL = Reliable Detection Limit (2 × MDL)
Results are not corrected for surrogate or moisture values unless otherwise stated.

| | | | |
|---|---|---|---|
| Sample Description | FW-B#4, DLPC-2 | Maxxam Sample Number | 355486 |
| Sample Date & Time | | Maxxam Job Number | CA211074 |
| Sampled By | | Sample Access | |
| Sample Type | Grab | Sample Matrix | WATER |
| Sample Received Date | 2002/09/23 | Report Date | 2002/09/27 |
| Sample Station Code | | | |

TEST RESULTS ON FOURTH FRAC WATER SAMPLE
AFTER SECOND CLARIFICATION STEP

| | | | | QA/OC | | |
|---|---|---|---|---|---|---|
| PARAMETER DESCRIPTION | RESULTS | Units | INST. | Batch | MDL | RDL |
| Calculated Parameters | | | | | | |
| Anion Sum | 109 | meq/L | CALC | 196406 | N/A | N/A |
| Cation Sum | 93.4 | meq/L | CALC | 196406 | N/A | N/A |
| Hardness (CaCO3) | 2800 | mg/L | CALC | 196402 | 0.5 | 1 |
| Ion Balance | 0.86 | N/A | CALC | 196404 | 0.01 | 0.02 |
| Misc. Inorganics | | | | | | |
| Conductivity | 10900 | uS/cm | ECEL | 196519 | 0.02 | 0.04 |
| pH | 7.21 | N/A | TITR/ALK | 196523 | N/A | N/A |
| Anions | | | | | | |
| Alkalinity (PP as CaCO3) | <0.5 | mg/L | TITR/ALK | 196516 | 0.5 | 1 |
| Alkalinity (Total as CaCO3) | 25.1 | mg/L | TITR/ALK | 196516 | 0.5 | 1 |
| Bicarbonate (HCO3) | 30.6 | mg/L | TITR/ALK | 196516 | 0.5 | 1 |
| Carbonate (CO3) | <0.5 | mg/L | TITR/ALK | 196516 | 0.5 | 1 |
| Dissolved Chloride (Cl) | 3840 | mg/L | TECH/CL | 196427 | 0.5 | 1 |
| Dissolved Fluoride (F) | <0.05 | mg/L | | 196520 | 0.05 | 0.1 |
| Hydroxide (OH) | <0.5 | mg/L | TITR/ALK | 196516 | 0.5 | 1 |
| Dissolved Sulphate (SO4) | 5.6 | mg/L | IC/EC | 196555 | 0.1 | 0.2 |
| Nutrients | | | | | | |
| Dissolved Nitrate (N) | 0.195 | mg/L | IC/UV | 197179 | 0.003 | 0.006 |
| Nitrate plus Nitrite (N) | 0.195 | mg/L | CALC | 196408 | 0.003 | 0.006 |
| Dissolved Nitrite (N) | <0.003 | mg/L | IC/UV | 197179 | 0.003 | 0.006 |
| Physical Properties | | | | | | |
| Turbidity | 2.9 | NTU | TURB | 197100 | 0.1 | 0.2 |

N/A = Not Applicable
MDL = Method Detection Limit - Calculated on the basis of the instrument detection level, the dilution used, and the weight of the sample. RDL = Reliable Detection Limit (2 × MDL)
Results are not corrected for surrogate or moisture values unless otherwise stated.
Anion-Cation balance is lower than our normal limits; major ions checked, possibly due to matrix.

| | | | |
|---|---|---|---|
| Sample Description | FW-B#4, DLPC-2 | Maxxam Sample Number | 355486 |
| Sample Date & Time | | Maxxam Job Number | CA211074 |
| Sampled By | | Sample Access | |
| Sample Type | Grab | Sample Matrix | WATER |
| Sample Received Date | 2002/09/23 | Report Date | 2002/09/27 |
| Sample Station Code | | | |

Elements by Atomic Spectroscopy

| | | | | QA/QC | | |
|---|---|---|---|---|---|---|
| PARAMETER DESCRIPTION | RESULTS | Units | INST. | Batch | MDL | RDL |
| Elements | | | | | | |
| Total Aluminum (Al) | 4.38 | mg/L | ICPM | 196777 | 0.001 | 0.002 |
| Total Antimony (Sb) | 0.0007 | mg/L | ICPM | 196777 | 0.0002 | 0.0004 |
| Total Arsenic (As) | <0.005 | mg/L | ICPM | 196777 | 0.005 | 0.01 |
| Total Barium (Ba) | 1.22 | mg/L | ICPM | 196777 | 0.0002 | 0.0004 |
| Total Beryllium (Be) | <0.0002 | mg/L | ICPM | 196777 | 0.0002 | 0.0004 |
| Total Boron (B) | 2.93 | mg/L | ICPM | 196777 | 0.01 | 0.02 |
| Total Cadmium (Cd) | (0.0003) | mg/L | ICPM | 196777 | 0.0002 | 0.0004 |
| Total Calcium (Ca) | 1120 | mg/L | ICPA | 196744 | 0.3 | 0.6 |
| Total Chromium (Cr) | 0.019 | mg/L | ICPM | 196777 | 0.001 | 0.002 |
| Total Cobalt (Co) | 0.0015 | mg/L | ICPM | 196777 | 0.0003 | 0.0006 |
| Total Copper (Cu) | 0.0103 | mg/L | ICPM | 196777 | 0.0002 | 0.0004 |
| Total Iron (Fe) | 0.07 | mg/L | ICPA | 196744 | 0.01 | 0.02 |
| Total Lead (Pb) | (0.0004) | mg/L | ICPM | 196777 | 0.0003 | 0.0006 |
| Total Lithium (Li) | 0.062 | mg/L | ICPA | 196744 | 0.004 | 0.008 |
| Total Magnesium (Mg) | 5.3 | mg/L | ICPA | 196744 | 0.2 | 0.4 |
| Total Manganese (Mn) | 3.74 | mg/L | ICPA | 196744 | 0.004 | 0.008 |
| Total Molybdenum (Mo) | 0.0102 | mg/L | ICPM | 196777 | 0.0002 | 0.0004 |
| Total Nickel (Ni) | 0.0166 | mg/L | ICPM | 196777 | 0.0005 | 0.001 |
| Total Phosphorus (P) | <0.1 | mg/L | ICPA | 196744 | 0.1 | 0.2 |
| Total Potassium (K) | 25.4 | mg/L | ICPA | 196744 | 0.3 | 0.6 |
| Total Selenium (Se) | (0.007) | mg/L | ICPM | 196777 | 0.007 | 0.014 |
| Total Silicon (Si) | 0.21 | mg/L | ICPA | 196744 | 0.04 | 0.08 |
| Total Silver (Ag) | 0.0002 | mg/L | ICPM | 196777 | 0.0001 | 0.0002 |
| Total Sodium (Na) | 849 | mg/L | ICPA | 196744 | 0.5 | 1 |
| Total Strontium (Sr) | 0.921 | mg/L | ICPA | 196744 | 0.004 | 0.008 |
| Total Sulphur (S) | 2.2 | mg/L | ICPA | 196744 | 0.2 | 0.4 |
| Total Thallium (Tl) | <0.0002 | mg/L | ICPM | 196777 | 0.0002 | 0.0004 |
| Total Tin (Sn) | 0.006 | mg/L | ICPM | 196777 | 0.001 | 0.002 |
| Total Titanium (Ti) | 0.018 | mg/L | ICPM | 196777 | 0.001 | 0.002 |
| Total Uranium (U) | <0.0004 | mg/L | ICPM | 196777 | 0.0004 | 0.0008 |
| Total Vanadium (V) | 0.003 | mg/L | ICPM | 196777 | 0.001 | 0.002 |
| Total Zinc (Zn) | 0.0193 | mg/L | ICPM | 196777 | 0.0006 | 0.0012 |
| Total Zirconium (Zr) | 0.0026 | mg/L | ICPM | 196777 | 0.0002 | 0.0004 |
| Cations | | | | | | |
| Dissolved Calcium (Ca) | 1110 | mg/L | ICPA | 197317 | 0.3 | 0.6 |
| Dissolved Magnesium (Mg) | 5.1 | mg/L | ICPA | 197317 | 0.2 | 0.4 |
| Dissolved Potassium (K) | 25.0 | mg/L | ICPA | 197317 | 0.3 | 0.6 |
| Dissolved Sodium (Na) | 846 | mg/L | ICPA | 197317 | 0.5 | 1 |
| Dissolved Iron (Fe) | <0.01 | mg/L | ICPA | 196746 | 0.01 | 0.02 |
| Dissolved Manganese (Mn) | 3.62 | mg/L | ICPA | 197317 | 0.004 | 0.008 |

MDL = Method Detection Limit —Calculated on the basis of the instrument detection level, the dilution used, and the weight of the sample. RDL = Reliable Detection Limit (2 × MDL)
() = Result < RDL and is subject to reduced levels of confidence
Results are not corrected for surrogate or moisture values unless otherwise stated.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for treating fracturing water comprising:
(a) passing contaminated fracturing water containing solids and liquid through a mechanical separator to remove solids from the liquid;
(b) treating the fracturing water liquid with an alkaline agent to increase the pH of the liquid to a level above 9;
(c) adding a coagulant to the fracturing water liquid to form an agglomerate and separating the agglomerate from the fracturing water liquid;
(d) reducing the pH of the fracturing water liquid of step (c) to a level of less than about 5.5; and
(e) adding an oxidizing agent to the fracturing water liquid of step (d) to oxidize and remove oxidizable impurities in the fracturing water liquid.

2. A method as claimed in claim 1 wherein the oxidation and acidification steps (d) and (e) are reversed.

3. A method as claimed in claim 1 wherein hydrated lime and caustic soda are added at step (b) to increase the pH of the fracturing water to a level of above about 9.

4. A method as claimed in claim 1 wherein both a flocculating agent and a coagulant are added to the fracturing water liquid in step (c).

5. A method as claimed in claim 1 wherein an inorganic acid is added to the fracturing water liquid at step (d) to reduce the pH to less than 5.5.

6. A method as claimed in claim 5 wherein the water that is produced from the second clarification step is passed through a sand water filter or a sediment cartridge filter to remove remaining particles in the liquid.

7. A method as claimed in claim 1 wherein in step (d), the liquid is neutralized by reducing the pH to about 7.0.

8. A method as claimed in claim 7 wherein the neutralization and oxidation steps (d) and (e) are reversed.

9. A method as claimed in claim 1 wherein the fracturing water liquid that remains after oxidized particles are removed in step (e) is subjected to a second clarification step which includes a second acidification step, followed by an oxidation step.

10. A method as claimed in claim 9 wherein a coagulant is added to the fracturing water liquid during the second clarification step.

11. A method as claimed in claim 10 wherein a flocculent is also added to the fracturing water liquid during the second clarification step.

12. A method as claimed in claim 11 wherein the fracturing water liquid from the second clarification step is neutralized before being reused as water.

13. A method as claimed in claim 12 wherein the water that is produced from the second clarification step is polished by being passed through a sand water filter or a sediment cartridge filter to remove remaining particles in the liquid.

14. A method as claimed in claim 1 wherein the fracturing water liquid in step (a) is oxidized after being mechanically separated and before proceeding to step (b), and in step (d) the pH of the liquid is reduced to about 7.0

15. A method as claimed in claim 14 wherein a flocculating agent is added along with a coagulant in step (c).
